(19) United States
(12) Patent Application Publication
(10) Pub. No.: US 2023/0031419 A1
(43) Pub. Date: Feb. 2, 2023

(54) PRECEDING VEHICLE DETERMINATION SYSTEM AND PRECEDING VEHICLE DETERMINATION METHOD

(71) Applicant: Mitsubishi Electric Corporation, Tokyo (JP)

(72) Inventors: Yuji SHIMIZU, Tokyo (JP); Fumiaki TAKAGI, Tokyo (JP); Toshihide SATAKE, Tokyo (JP); Kazuhiro NISHIWAKI, Tokyo (JP)

(73) Assignee: Mitsubishi Electric Corporation, Tokyo (JP)

(21) Appl. No.: 17/789,563

(22) PCT Filed: Jan. 27, 2020
(86) PCT No.: PCT/JP2020/002706

§ 371 Date: Jun. 28, 2022

(51) Int. Cl. B60W 30/16; B60W 40/072; B60W 40/105; B60W 50/00

(52) U.S. Cl. CPC B60W 30/16; B60W 40/072; B60W 40/105; B60W 50/0098; B60W 2050/0056; B60W 2552/30; B60W 2552/53; B60W 2554/4041; B60W 2554/80; B60W 2556/10

(57) ABSTRACT

To provide a preceding vehicle determination system and a preceding vehicle determination method which can improve the determination accuracy of the preceding vehicle, considering an estimation error of the traveling lane of the own vehicle. A preceding vehicle determination system and a preceding vehicle determination method estimates a high probability region which is a region where the own vehicle probably travels and estimates a middle probability region which is a region where a possibility that the own vehicle travels is lower than the high probability region, based on the traveling state of the own vehicle; and determines whether the front vehicle is a which is traveling forward in a traveling lane of the own vehicle, based on the position history of the front vehicle, the high probability region, and the middle probability region.

### TECHNICAL FIELD

The present disclosure relates to a preceding vehicle determination system and a preceding vehicle determination method.

### BACKGROUND ART

Mainly, during traveling highway, aiming at reducing the load due to accelerator operation of driver, the vehicle distance control apparatus which maintains automatically an appropriate vehicle distance with a preceding vehicle which travels forward in the traveling lane of the own vehicle becomes popular.

When controlling the vehicle distance with the preceding vehicle, it is necessary to determine appropriately the preceding vehicle which becomes an object of the vehicle distance control.

As the technology performing this kind determination, comparing the position information of the front vehicle detected by the sensor with the estimated lane which is an estimated traveling lane of the own vehicle, it is determined whether the front vehicle is the preceding vehicle (for example, patent document 1 and the like), based on whether the detected front vehicle is included in the estimated lane.

The method to use only a part close to the own vehicle among the estimated lanes by storing the traveling locus (the past position information) of the front vehicle, and using the past position information of the front vehicle, or the method not to use the estimated lane substantially are also known (patent documents 2 to 4).

### CITATION LIST

### Patent Literature

Patent document 1: JP 2001-014597 A
Patent document 2: JP 2010-146177 A
Patent document 3: JP 2011-098586 A
Patent document 4: JP 2013-125403 A

### SUMMARY OF INVENTION

### Technical Problem

Recently, due to the improvement in automobile performance and the like, the vehicles which travel at a speed faster than previous are increasing in number. Other than Japan, there are countries which set a speed limit higher than Japan. Even in Japan, there are road intervals where the speed limit of highway is increased experimentally.

Generally, it is recommended to extend the vehicle distance, as the travelling speed becomes higher from a viewpoint of safe driving. Accordingly, when traveling at a speed higher than previous, the vehicle distance becomes longer than previous, and it is necessary to determine a farther distant preceding vehicle than previous.

In addition, also from a physical viewpoint purely, as the relative speed difference between the own vehicle and the preceding vehicle becomes larger, a distance required for decelerating to follow the preceding vehicle increases. That is to say, when traveling at a speed higher than previous, it is expected that the relative speed difference with the preceding vehicle becomes larger than previous. Accordingly, it is necessary to determine whether it is the preceding vehicle in a stage farther than previous, and start necessary deceleration earlier.

However, since accuracy of the estimated lane is usually deteriorated as it becomes farther, the determination accuracy in a distant place is deteriorated in the method (for example, patent document 1) which compares the estimated lane with the position information of the front vehicle, and determines the preceding vehicle. By this problem, the vehicle distance control apparatus may perform unnecessary acceleration and deceleration, and there is an adverse influence to riding comfort, fuel efficiency, and the like.

On the other hand, in the method which stores the past position information of the front vehicle, and determines the preceding vehicle after the own vehicle reaches or approaches the past position of the front vehicle, when the front vehicle changes lane, delay in determination that the front vehicle is the preceding vehicle (or, delay in cancellation from the preceding vehicle) occurs. By this problem, delay in deceleration or acceleration may occur in the vehicle distance control apparatus. There is an adverse influence to safeness of the driver to the vehicle distance control apparatus, and riding comfort.

In patent document 2, by comparing the current position of the own vehicle with the traveling locus (the past position information) of the front vehicle, the preceding vehicle determination is performed, without using the estimated lane whose accuracy is deteriorated in a distant place. On the other hand, when the front vehicle changed lane and entered into the own-lane, a timing determined to be the preceding vehicle is delayed (or, when the front vehicle leaved from the own-lane, a cancellation timing of the preceding vehicle is delayed).

In patent document 3, by providing processing of the name “preceding vehicle lane separation detection”, a cancellation of determination is hastened, the cancellation of determination in the case where the own vehicle changed lane is hastened by this idea. However, a countermeasure is not still provided to the case where the preceding vehicle changed lane, but the delay in cancellation from the preceding vehicle occurs.

In patent document 4, a plurality of position information which differs in the elapsed time after acquisition among the past position information of the front vehicle is compared with the current estimated lane; a probability (following probability) determined as the preceding vehicle is acquired from a predetermined map, based on each comparison result; after that, based on an integrated following probability which integrated these following probabilities, it is determined whether it is the preceding vehicle. However, about an important part for achieving coexistence between a determination delay reduction and a determination accuracy, that is, how many the position information at any past time point is used, there is no concrete description.

In the technology of each patent documents, since the probability of the estimated lane, that is, degree of the estimation error of the traveling lane of the own vehicle is not considered, the inventor considered that the determination accuracy of the preceding vehicle could not be sufficiently improved.

Then, the purpose of the present disclosure is to provide a preceding vehicle determination system and a preceding vehicle determination method which can improve the determination accuracy of the preceding vehicle, considering an estimation error of the traveling lane of the own vehicle.

### Solution to Problem

The preceding vehicle determination system according to the present disclosure including:

a traveling state detection unit that detects a position and a traveling state of an own vehicle;

a front vehicle position detection unit that detects a position of a front vehicle located in front of the own vehicle;

a position history calculation unit that calculates a position history of the front vehicle on a basis of a current position of the own vehicle, based on the positions of the front vehicle and the positions of the own vehicle which were detected at plural time points;

a region estimation unit that estimates a high probability region which is a region where the own vehicle probably travels and estimates a middle probability region which is a region where a possibility that the own vehicle travels is lower than the high probability region, based on the traveling state of the own vehicle; and

a preceding vehicle determination unit that determines whether the front vehicle is a preceding vehicle which is traveling forward in a traveling lane where the own vehicle is traveling, based on the position history of the front vehicle, the high probability region, and the middle probability region.

A preceding vehicle determination method according to the present disclosure including:

a traveling state detection step of detecting a position and a traveling state of an own vehicle;

a front vehicle position detection step of detecting a position of a front vehicle located in front of the own vehicle;

a position history calculation step of calculating a position history of the front vehicle on a basis of a current position of the own vehicle, based on the positions of the front vehicle and the positions of the own vehicle which were detected at plural time points;

a region estimation step of estimating a high probability region which is a region where the own vehicle probably travels, based on the traveling state of the own vehicle, and estimates a middle probability region which is a region where a possibility that the own vehicle travels is lower than the high probability region; and

a preceding vehicle determination step of determining whether the front vehicle is a preceding vehicle which is traveling forward in a traveling lane where the own vehicle is traveling, based on the position history of the front vehicle, the high probability region, and the middle probability region.

### Advantage of Invention

According to the preceding vehicle determination system and the preceding vehicle determination method of the present disclosure, by estimating the high probability region and the middle probability region in which possibility that the own vehicle travels differs, based on the traveling state of the own vehicle, and comparing with the position history of the front vehicle by combining the high probability region and the middle probability region, it can be determined whether the front vehicle is the preceding vehicle. Therefore, the detection accuracy of the preceding vehicle can be improved considering influence of the estimation error of the traveling lane of the own vehicle.

### BRIEF DESCRIPTION OF THE DRAWINGS

FIG. 1 is a schematic configuration figure of the preceding vehicle determination system according to Embodiment 1;

FIG. 2 is a hardware configuration diagram of the information processing apparatus according to Embodiment 1;

FIG. 3 is a flowchart for explaining schematic processing of the preceding vehicle determination system according to Embodiment 1;

FIG. 4 is a figure explaining the coordinate system of the own vehicle according to Embodiment 1;

FIG. 5 is a figure explaining the position history of the front vehicle stored in the storage apparatus according to Embodiment 1;

FIG. 6 is a figure explaining the update of the position history of the front vehicle according to Embodiment 1;

FIG. 7 is a figure explaining the estimated lane according to Embodiment 1;

FIG. 8 is a figure explaining the estimated lane according to Embodiment 1;

FIG. 9 is a figure explaining the boundary line of the estimated lane according to Embodiment 1;

FIG. 10 is a time chart explaining the steering fluctuation according to Embodiment 1;

FIG. 11 is a figure explaining the frequency distribution of the curvature error according to Embodiment 1;

FIG. 12 is a figure explaining setting of the high probability region and the middle probability region according to Embodiment 1;

FIG. 13 is a figure explaining setting of the high probability region and the middle probability region according to Embodiment 1;

FIG. 14 is a figure explaining change of the standard deviation due to the speed according to Embodiment 1;

FIG. 15 is a figure explaining adjustment of the high probability region and the middle probability region according to Embodiment 1;

FIG. 16 is a figure explaining adjustment of the high probability region and the middle probability region according to Embodiment 1;

FIG. 17 is a figure explaining determination of the preceding vehicle according to Embodiment 1;

FIG. 18 is a figure explaining determination of the preceding vehicle according to Embodiment 1;

FIG. 19 is a figure explaining determination of the preceding vehicle according to Embodiment 1;

FIG. 20 is a figure explaining determination of the preceding vehicle according to Embodiment 1;

FIG. 21 is a flowchart explaining the preceding vehicle determination processing according to Embodiment 1;

FIG. 22 is a figure explaining setting of the high probability region and the middle probability region according to Embodiment 2;

FIG. 23 is a figure explaining adjustment of the high probability region and the middle probability region according to Embodiment 2;

FIG. 24 is a figure explaining adjustment of the high probability region and the middle probability region according to Embodiment 2;

FIG. 25 is a figure explaining the determination standard distance and the determination limitation distance according to the speed according to Embodiment 3; and

FIG. 26 is a flowchart for explaining of the preceding vehicle determination processing according to Embodiment 3.

### DETAILED DESCRIPTION OF THE EMBODIMENTS

### 1. Embodiment 1

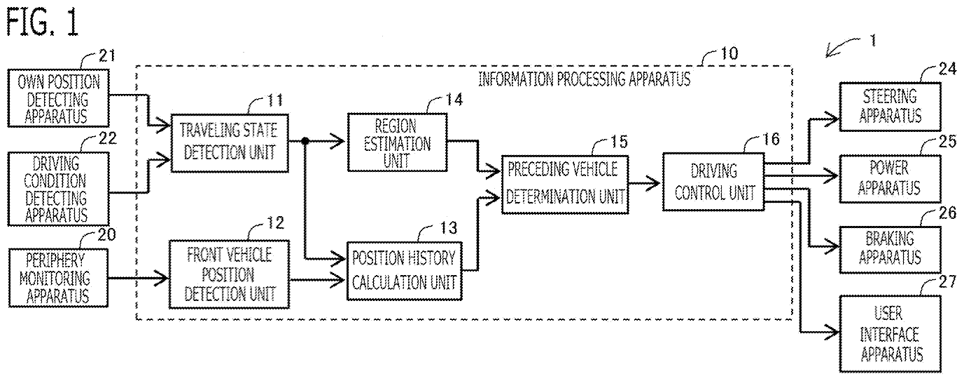

A preceding vehicle determination system 1 according to Embodiment 1 will be explained with reference to drawings. FIG. 1 is a schematic configuration diagram of the preceding vehicle determination system 1 according to the present embodiment.

In the present embodiment, the preceding vehicle determination system 1 is mounted on an own vehicle. The preceding vehicle determination system 1 is provided with an information processing apparatus 10, a periphery monitoring apparatus 20, an own position detecting apparatus 21, a driving condition detecting apparatus 22 and the like.

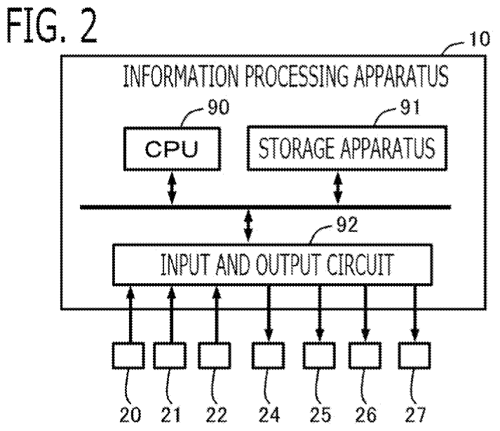

The information processing apparatus 10 is provided with processing units of a traveling state detection unit 11, a front vehicle position detection unit 12, a position history calculation unit 13, a region estimation unit 14, a preceding vehicle determination unit 15, a driving control unit 16, and the like. Each processing of the information processing apparatus 10 is realized by processing circuits provided in the information processing apparatus 10. As shown in FIG. 2, specifically, the information processing apparatus 10 is provided with an arithmetic processor 90 such as CPU (Central Processing Unit), storage apparatuses 91, an input and output circuit 92 which outputs and inputs external signals to the arithmetic processor 90, and the like.

As the arithmetic processor 90, ASIC (Application Specific Integrated Circuit), IC (Integrated Circuit), DSP (Digital Signal Processor), FPGA (Field Programmable Gate Array), GPU (Graphics Processing Unit), a neural processing chip, various kinds of logical circuits, various kinds of signal processing circuits, and the like may be provided. As the arithmetic processor 90, a plurality of the same type ones or the different type ones may be provided, and each processing may be shared and executed. As the storage apparatuses 91, there are provided a RAM (Random Access Memory) which can read data and write data from the arithmetic processor 90, a ROM (Read Only Memory) which can read data from the arithmetic processor 90, and the like. As the storage apparatuses 91, various kinds of storage apparatus, such as a flash memory, EEPROM (Electrically Erasable Programmable Read Only Memory), a hard disk, and a DVD apparatus may be used.

The input and output circuit 92 is provided with an A/D converter, an input port, a driving circuit, an output port, a communication device, and the like. The input and output circuit 92 is connected with the periphery monitoring apparatus 20, the own position detecting apparatus 21, the driving condition detecting apparatus 22, and the like, and inputs these output signals into the arithmetic processor 90. The input and output circuit 92 is connected to a steering apparatus 24, a power apparatus 25, a braking apparatus 26, an user interface apparatus 27, and the like, and outputs the output signal of the arithmetic processor 90 to these.

Then, the arithmetic processor 90 runs software items (programs) stored in the storage apparatus 91 such as a ROM and collaborates with other hardware devices in the information processing apparatus 10, such as the storage apparatus 91, and the input and output circuit 92, so that the respective functions of the 11 to 16 included in the information processing apparatus 10 are realized. Various kinds of setting data items to be utilized in the processing units 11 to 16 are stored, as part of software items (programs), in the storage apparatus 91 such as ROM. Each function of the preceding vehicle determination system 1 will be described in detail below.

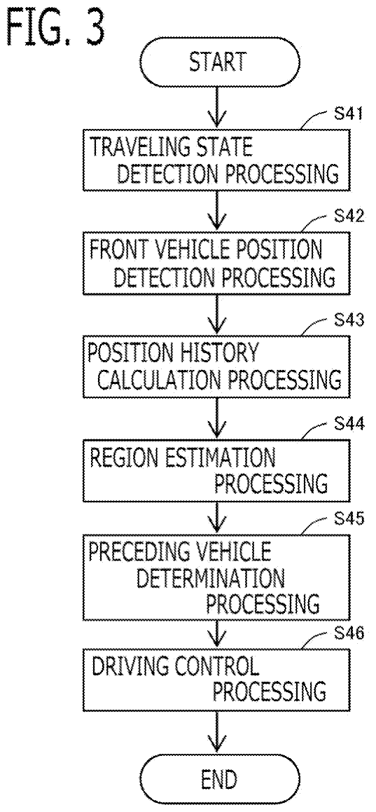

FIG. 3 is a schematic flowchart for explaining the procedure (the preceding vehicle determination method) of processing of the preceding vehicle determination system 1 according to the present embodiment. The processing of the flowchart in FIG. 3 is recurrently executed every predetermined operation period by the arithmetic processor 90 executing software (a program) stored in the storage apparatus 91.

1-1. Traveling State Detection Unit 11

In the step S41 of FIG. 3, the traveling state detection unit 11 executes a traveling state detection processing (a traveling state detection step) that detects the position and traveling state of an own vehicle. In the present embodiment, the traveling state detection unit 11 detects a position of the own vehicle, based on the output signal of the own position detecting apparatus 21.

As the own position detecting apparatus 21, one or more of various kinds of detecting devices, such as a receiver of Global Navigation Satellite System (GNSS), an acceleration sensor, and an azimuth sensor, are used, for example.

In the present embodiment, the traveling state detection unit 11 detects a curvature of the traveling course of the own vehicle as a traveling state of the own vehicle, based on the output signal of the driving condition detecting apparatus 22. For example, a rotation speed sensor is provided in each wheel of the own vehicle as the driving condition detecting apparatus 22. And, the traveling state detection unit 11 detects a rotational speed of each wheel, based on the output signal of the rotation speed sensor of each wheel; calculates a speed and a yaw rate of the own vehicle, based on an average value and a difference of the rotational speed of each wheel; and calculates the curvature of the traveling course, based on the speed and the yaw rate of the own vehicle. Alternatively, a vehicle speed sensor and a yaw rate sensor may be provided as the driving condition detecting apparatus 22. The traveling state detection unit 11 may detect the speed and the yaw rate of the own vehicle, based on the output signal of the vehicle speed sensor and the yaw rate sensor, and calculate the curvature of the traveling course, based on the speed and the yaw rate of the own vehicle. A steering angle sensor which detects a steering angle of the wheel may be provided as the driving condition detecting apparatus 22. And, the traveling state detection unit 11 may detect a steering angle, based on the output signal of the steering angle sensor, and calculate the curvature of the traveling course based on the steering angle.

1-2. Front Vehicle Position Detection Unit 12

In the step S42 of FIG. 3, the front vehicle position detection unit 12 executes a front vehicle position detection processing (a front vehicle position detection step) that detects a position of a front vehicle located in front of the own vehicle. In the present embodiment, the front vehicle position detection unit 12 detects the position of the front vehicle based on the output signal of the periphery monitoring apparatus 20. As the periphery monitoring apparatus 20, a camera, a radar, and the like which monitor in front of the own vehicle are provided. As the radar, a millimeter wave radar, a laser radar, an ultrasonic radar, and the like are used. If the camera is used, by performing various kinds of well-known image processing to a picture in front of the own vehicle imaged by the camera, the front vehicle which exists in front of the own vehicle is detected, and a relative position of the front vehicle with respect to the own vehicle is detected. If the radar is used, a millimeter wave, a laser, or an ultrasonic wave is irradiated to the front of the own vehicle, and the relative position of the front vehicle with respect to the own vehicle is detected, based on a irradiation direction, and a time difference until receiving a reflected wave reflected by the front vehicle which exists in the front.

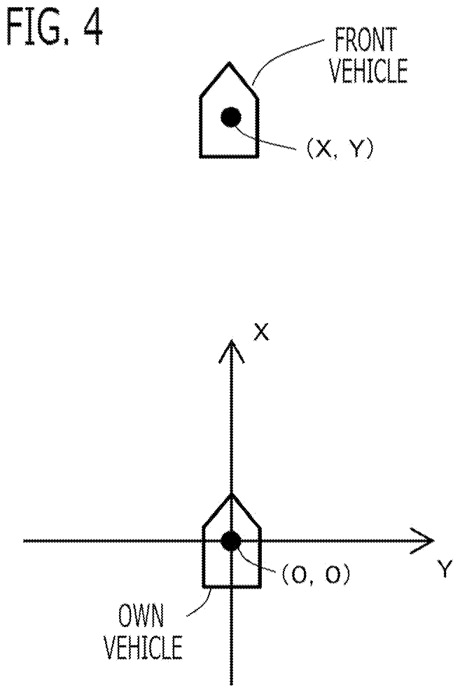

As shown in FIG. 4, the front vehicle position detection unit 12 detects a relative position (X, Y) of the front vehicle with respect to the own vehicle, on a coordinate system (hereinafter, referred to as an own vehicle coordinate system) where the front direction and the lateral direction of the present own vehicle are set as two coordinate axes X and Y. The front direction (also called as a traveling direction) of the own vehicle is set as the X-axis, and the lateral direction (in this example, right direction) of the own vehicle orthogonal to the front direction is set as the Y-axis. The own vehicle is located at zero point of the X-axis and the Y-axis. The position of the front vehicle are a representative position, such as a center position in the lateral direction of the front vehicle. The front vehicle position detection unit 12 detects the relative position of each front vehicle, when a plurality of front vehicles are detected.

1-3. Position History Calculation Unit 13

In the step S43 of FIG. 3, the position history calculation unit 13 executes a position history calculation processing (a position history calculation step) that calculates a position history of the front vehicle on a basis of a current position of the own vehicle, based on the positions of the front vehicle and the positions of the own vehicle which were detected at plural time points.

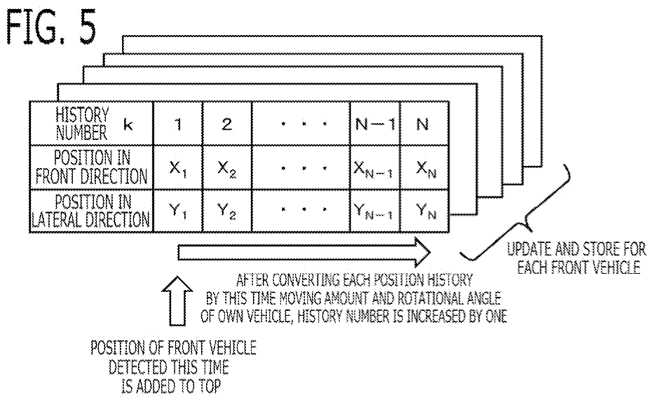

As shown in FIG. 5, the position history calculation unit 13 stores the relative position (Xₖ, Yₖ) of the front vehicle detected at each time point to the rewritable storage apparatus 91 such as RAM, by correlating with a history number k (k=1, 2, . . . , N−1, N). The position history calculation unit 13 stores the position history to the storage apparatus 91 about each front vehicle, when the plurality of front vehicles are detected.

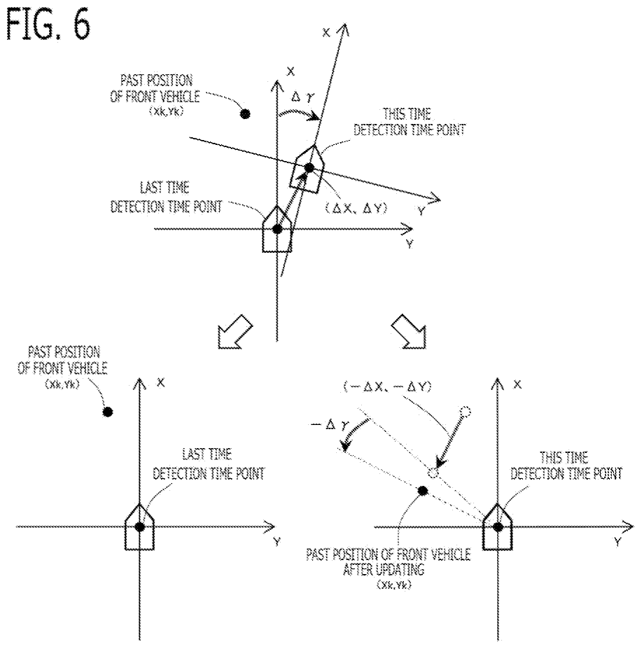

The position of the front vehicle detected at each time point is the relative position with respect to the own vehicle at each time point. Accordingly, as shown in FIG. 6, when the own vehicle moves, the relative position of the past front vehicle viewed on the basis of the current position of the own vehicle (the own vehicle coordinate system) moves to a direction opposite to the moving direction of the own vehicle by moving amount of the own vehicle, and rotates to a direction opposite to the rotation direction of the own vehicle by rotational angle of the own vehicle.

Then, as shown in the next equation, for every detection period, the position history calculation unit 13 performs a transformation that moves and rotates the position history (Xₖ, Yₖ) corresponding to the relative position detected at each past detection time point (each history number k), to a direction opposite to the moving amount (ΔX, AY) and the rotational angle Δy of the own vehicle (the own vehicle coordinate system) in the detection period which are detected at this time detection time point, respectively; and updates the position history (Xₖ, Yₖ) corresponding to the relative position detected at each detection time point. That is to say, for every detection period, the position history calculation unit 13 performs cumulatively the transformation that reflects moving of the own vehicle between periods on the relative position of each detection time point, and updates the relative position of each detection time point.

Xₖ=+(Xₖ−ΔX)cos Δγ+(Yₖ−ΔY)sin Δγ

Yₖ=−(Yₖ−ΔY)sin Δγ+(Yₖ−ΔY)cos Δγ (1)

In the present embodiment, as shown in the next equation, the position history calculation unit 13 reads the relative position Xₖ, Yₖ of each past history number k from the storage apparatus 91 and performs the transformation of the equation (1); and after that, stores to the storage apparatus 91 as the relative position Xₖ₊₁, Yₖ₊₁ of the history number k+1 that the history number k was increased by one. The position history calculation unit 13 stores the relative position X_{new}, Y_{new} of the front vehicle detected newly to the storage apparatus 91 as the relative position X₁, Y₁ of the history number k=1.

Xₖ₊₁=Xₖ

Yₖ₊₁=Yₖ

X₁=X_{new}

Y₁=Y_{new} (2)

Utilizing that the traveling speed in the front direction of the own vehicle becomes almost equal to the travelling speed of the own vehicle if the sideslip does not occur, and the moving amount ΔX in the front direction is calculated by multiplying the detection period to the travelling speed of the own vehicle. Since the traveling speed in the lateral direction of the own vehicle becomes almost zero if the detection period is short enough, the moving amount ΔY in the lateral direction is set to zero. The rotational angle Δy is calculated by multiplying the detection period to the yaw rate of the own vehicle detected by the traveling state detection unit 11. The moving amount ΔX, AY and the rotational angle Δy may be calculated based on the moving amount between the detection periods of the position of the own vehicle detected by the receiver of GNSS and the like.

The position history calculation unit 13 may upper-limit the history number of the position history of the front vehicle by an upper limit number, and erase the position history of the front vehicle older than the upper limit number. Alternatively, the position history calculation unit 13 may erase the position history of the front vehicle which becomes behind the own vehicle.

1-4. Region Estimation Unit 14

In the step S44 of FIG. 3, the region estimation unit 14 executes a region estimation processing (a region estimation step) that estimates a high probability region which is a region where the own vehicle probably travels and estimates a middle probability region which is a region where a possibility that the own vehicle travels is lower than the high probability region, based on the traveling state of the own vehicle detected by the traveling state detection unit 11. In the present embodiment, the curvature of the traveling course of the own vehicle is used as the traveling state of the own vehicle.

<Estimated Lane According to Curvature>

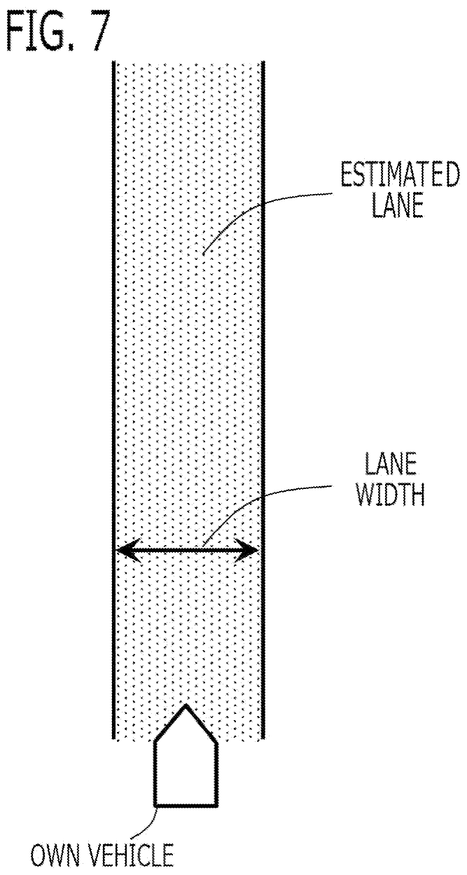

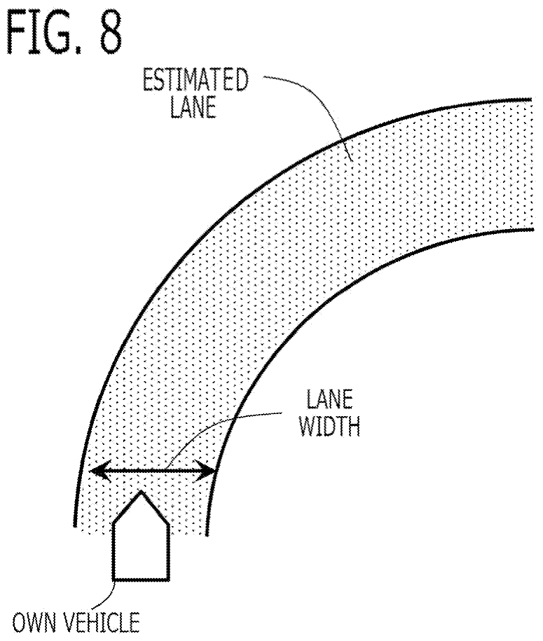

FIG. 7 and FIG. 8 show an estimated lane which extends forward from the position of the current own vehicle according to the curvature of the traveling course of the own vehicle. The estimated lane has a lane width. FIG. 7 shows the estimated lane when the own vehicle is traveling straightly and the curvature of the traveling course is zero. FIG. 8 shows the estimated lane when the own vehicle is turning on right side and the curvature of the traveling course is the curvature turning on right side. For example, if circular arcs are drawn about a turning center, by setting, as radiuses, two values obtained by adding and subtracting a half value of the lane width to the turning radius corresponding to curvature, a boundary line of left side and a boundary line of right side of the estimated lane are obtained. A region interposed between the boundary lines of left side and right side becomes the estimated lane.

These turning radiuses and turning center can be calculated using a reciprocal (a curvature radius) of the curvature of the traveling course of the own vehicle detected by the traveling state detection unit 11, for example.

On the other hand, if the estimated lane is calculated, using the curvature of the traveling course directly, a calculation of square root is required and the computation load becomes high. A case classification is required between the straight traveling and the turning. And, in gentle turning which is close to the straight traveling, the curvature radius becomes large too much, and a required word size for calculating without overflow becomes large. In order to avoid such bad influence on calculation, it is considered to calculate the estimated lane using an approximation equation showing in the next equation.

YL(X)=C0L+C1L×X+C2L×X²

YR(X)=C0R+C1R×X+C2R×X² (3)

Herein, the first equation of the equation (3) is an approximation equation of the boundary line of left side of the estimated lane, and a position YL in the lateral direction of the boundary line of left side at each position X in the front direction is calculated. The second equation of the equation (3) is an approximation equation of the boundary line of right side of the estimated lane, and a position YR in the lateral direction of the boundary line of right side at each position X in the front direction is calculated. The first equation and the second equation of the equation (3) are second-order polynomials in each of which the position X in the front direction is a variable.

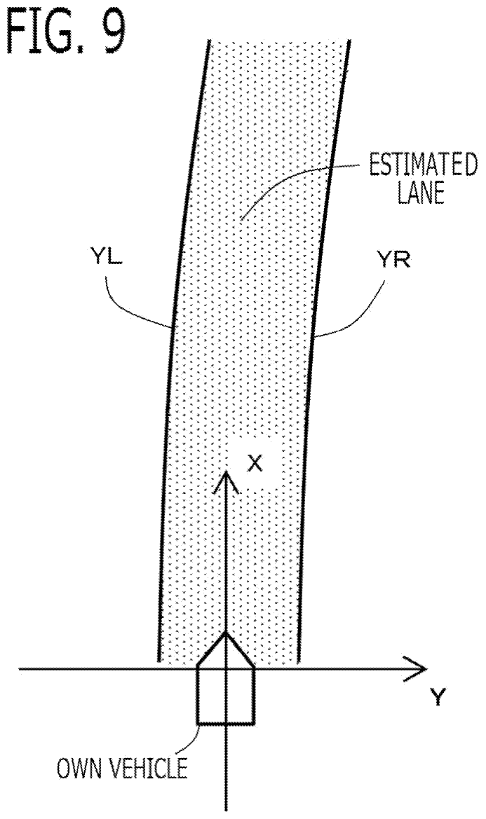

FIG. 9 shows the relationship among the own vehicle coordinate system, the left side boundary line YL, the right side boundary line YR, and the estimated lane. A region between the left side boundary line YL and the right side boundary line YR which are calculated by the equation (3) becomes the estimated lane. A negative value of the half value of lane width is set as the zero-order coefficient C0L of the left side boundary line. A positive value of the half value of lane width is set as the zero-order coefficient C0R of the right side boundary line. Zero is set as the first-order coefficients C1L, C1R of the left side boundary line and the right side boundary line. A half value of the curvature of the traveling course is set as the second-order coefficients C2L, C2R of the left side boundary line and the right side boundary line. The curvature of the right curve is set to positive, and the curvature of the left curve is set to negative.

Each coefficient C0L, C1L, C2L, C0R, C1R, C2R may be increased or decreased to some extent, according to a setting position of the origin of the own vehicle coordinate system within the own vehicle (alternatively, in special case, outside the own vehicle). For example, when the turning radius is comparatively small, in order to obtain accuracy, each coefficient C0L, C1L, C2L, C0R, C1R, C2R may be adjusted so as to correct an offset of the origin of the own vehicle coordinate system from the neutral steer point (alternatively, approximately, the right and left center of the rear wheel axle), according to the offset of the origin of the own vehicle coordinate system, or to correct a side slipping amount at the origin of the own vehicle coordinate system. Since the boundary lines of left side and right side are strictly increased or decreased by the half of lane width than the turning radius of the own vehicle, respectively, the curvature radius may be corrected by a difference of its turning radiuses, and the secondary coefficients C2L, C2R may be set.

The own vehicle coordinate system is explained using the coordinate system which sets the position of the own vehicle to the origin, sets the front direction to the positive direction of the X-axis, sets the right to the positive direction of the Y-axis, and sets the right-handed rotation (clockwise rotation) to the positive direction of rotation viewing the own vehicle from above. Any coordinate system may be set. The coordinate system is not limited to the exemplified coordinate system. The axis may be reversed so that the positive/negative of the coordinate system and the positive/negative of the equation may coincide. The coordinate system may be a coordinate system in which various offset is added and parallel moving is performed.

<Normal Distribution of Curvature Error Due to Steering Fluctuation>

By the way, the own vehicle does not always pass through the inside of the estimated lane. If it is a short distance, the own vehicle passes through the inside of the estimated lane almost certainly. However, as it becomes a longer distance, the own vehicle may not pass through the inside of the estimated lane.

As a main cause, a steering fluctuation of the driver of the own vehicle is mentioned, for example. The driver is not always steering so as to trace the lane completely, and is steering with some variations. Accordingly, the curvature of the traveling course of the own vehicle detected by the traveling state detection unit 11 does not always coincide with the curvature of the lane. As it becomes a longer distance, an error of the position Y in the lateral direction due to this kind mismatch of curvature increases. With respect to the same curvature error, the error of the lateral position Y is expanded approximately in proportion to a square of the position X in the front direction.

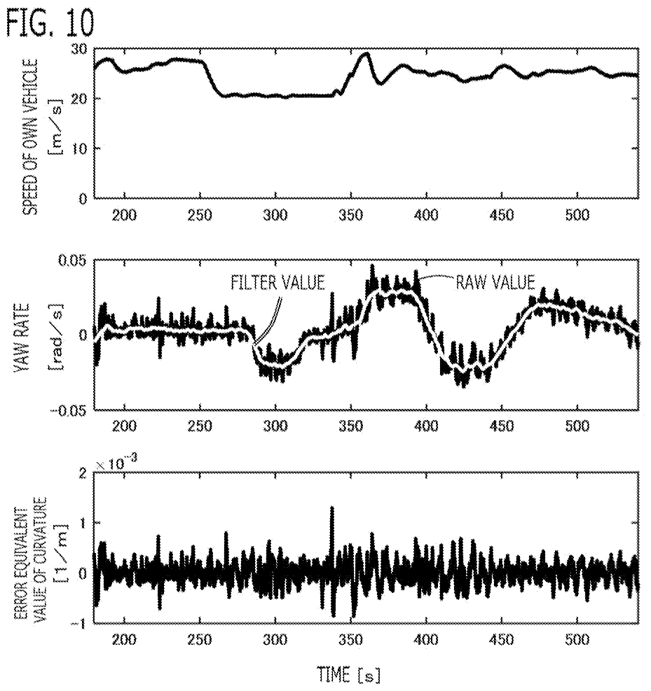

FIG. 10 shows an example of the behavior of this steering fluctuation. This figure shows a time chart when the driver requested by the inventors drives the highway in Japan. This figure shows the speed of the own vehicle, the yaw rate of the own vehicle, and an error equivalent value (curvature error) of the curvature of the traveling course with respect to the curvature of the traveling lane. The “raw value” and the “filter value” are shown in the graph of the yaw rate of the own vehicle. The “raw value” plots the yaw rate detected by the traveling state detection unit 11. The “filter value” shows a value after performing a low pass filter processing (a smoothing processing) of the raw value. This “filter value” becomes equivalent to a value obtained by converting the curvature of the traveling lane into the yaw rate. Since the “raw value” includes the above-mentioned steering fluctuation, it is fluctuating centering on the “filter value” of the yaw rate corresponding to the curvature of the traveling lane. A value obtained by subtracting the “filter value” from the “raw value” of the yaw rate is plotted as the curvature error.

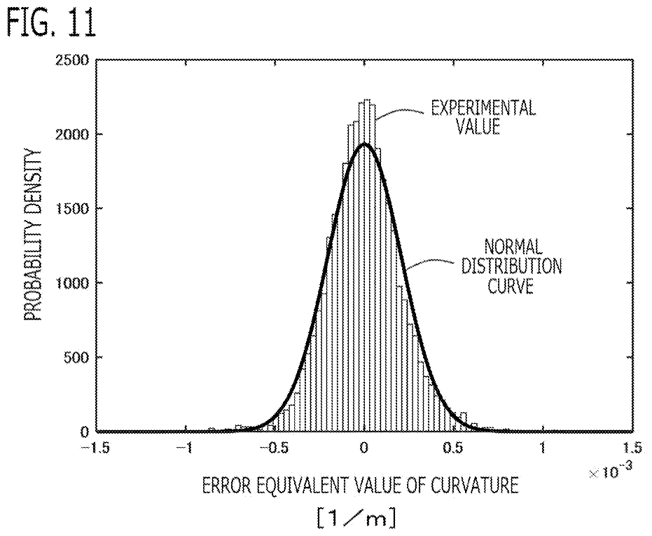

An example of a frequency distribution of the curvature error due to the steering fluctuation is shown in FIG. 11. This shows the frequency distribution of the curvature error calculated by subtracting the “filter value” from the “raw value” of the yaw rate, in the same traveling as FIG. 10. The horizontal axis shows the curvature error, and the vertical axis shows the frequency converted into the probability density. The shape of the frequency distribution of the curvature error approximately coincides with the normal distribution curve plotted in a superimposing manner. Accordingly, it can be assumed that the curvature error due to the steering fluctuation in normal traveling becomes approximately the normal distribution. Even when the steering angle is controlled automatically, although the standard deviation becomes smaller than the driving of driver, there is a similar steering fluctuation, and the curvature error becomes approximately the normal distribution.

If it is assumed that the curvature error due to the steering fluctuation follows the normal distribution which has a predetermined standard deviation, a probability (two-sided probability) that an absolute value of the curvature error due to the steering fluctuation becomes more than a predetermined value, and an absolute value (two-sided percent point) of the curvature error that the two-sided probability becomes a predetermined percentage can be calculated.

<Estimation of High Probability Region and Middle Probability Region Using Normal Distribution>

Since there is the curvature error due to the steering fluctuation as mentioned above, the own vehicle does not always pass through the inside of the estimated lane calculated based on the curvature of the traveling course. However, utilizing that the curvature error follows the normal distribution, for example, by calculating an estimated lane (corresponds to a high probability region) where the lane is narrowed by a part corresponding to an absolute value of the curvature error that the two-sided probability becomes 5% (referred to as two-sided 5% point), it is guaranteed that the own vehicle travels the inside of the narrowed estimated lane at 95% probability or more. On the other hand, by calculating an estimated lane (corresponds to a high probability region and a middle probability region) where the lane is expanded by a part corresponding to an absolute value of the curvature error that the two-sided probability becomes 10% (referred to as two-sided 10% point), it is guaranteed that the own vehicle travels the outside of the expanded estimated lane at 10% probability or less.

Then, the region estimation unit 14 estimates the high probability region and the middle probability region, based on the curvature of the traveling course, and the error width of curvature.

The region estimation unit 14 estimates a region where an estimated lane which extends forward from the position of the current own vehicle according to the curvature of the traveling course detected by the traveling state detection unit 11 and has a lane width is narrowed corresponding to the error width of curvature, as the high probability region; and estimates a region other than the high probability region among a region where the estimated lane is expanded corresponding to the error width of curvature, as the middle probability region. The error width of curvature for estimation of the high probability region and the error width of curvature for estimation of the middle probability region may be set to different values. The lane width may be set to a preliminarily set standard value, or may be set based on the recognition result of the lane boundary lines of the traveling lane.

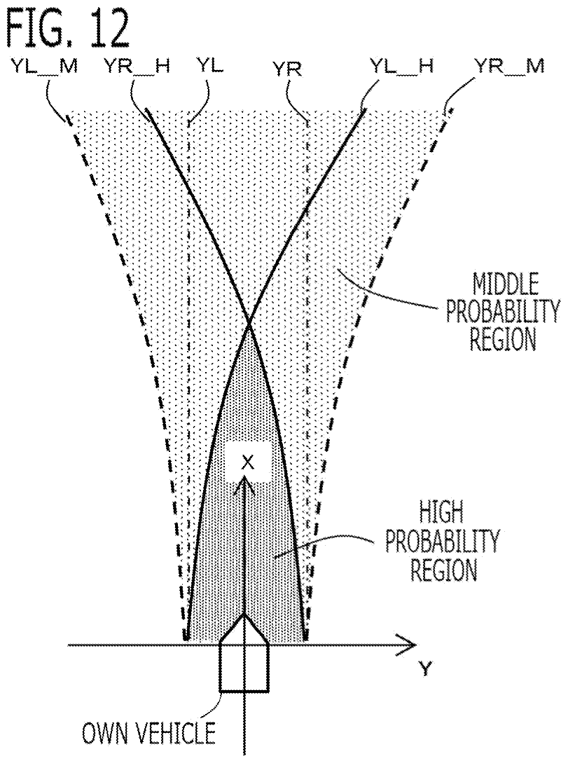

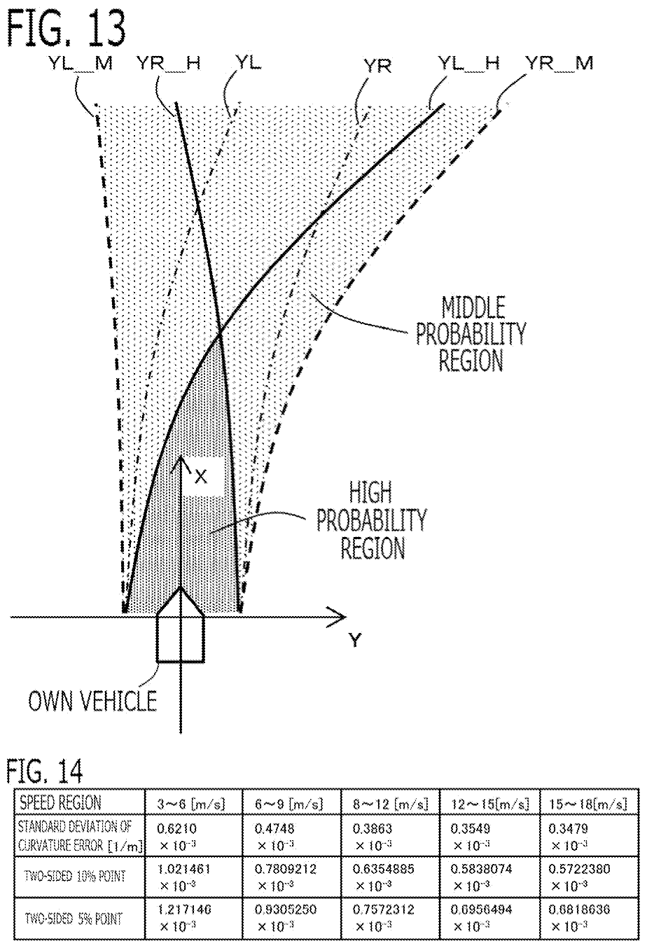

As shown in FIG. 12 and FIG. 13, the region estimation unit 14 estimates, as the high probability region, a region which becomes right side of a line YL_H which extends forward from an edge point of the traveling lane at left side of the current own vehicle, according to a curvature which is bent on right side from the curvature of the traveling course by the error width, and which becomes left side of a line YR_H which extends forward from an edge point of the traveling lane at right side of the current own vehicle, according to a curvature which is bent on left side from the curvature of the traveling course by the error width. And, the region estimation unit 14 estimates, as the middle probability region, a region other than the high probability region among a region which becomes right side of a line YL_M which extends forward from the edge point of the traveling lane at left side of the current own vehicle, according to a curvature which is bent on left side from the curvature of the traveling course by the error width, and which becomes left side of a line YR_M which extends forward from the edge point of the traveling lane at right side of the current own vehicle according to a curvature which is bent on right side from the curvature of the traveling course by the error width.

For example, a method to estimate using second-order polynomials similar to the equation (2) will be explained. The region estimation unit 14 calculates the left side boundary line YL_H and the right side boundary line YR_H of the high probability region using the next equation.

YL_H(X)=C0L+C11×X+(C2L+ΔC)×X²

YR_H(X)=C0R+C1R×X+(C2R−ΔC)×X² (4)

Herein, ΔC is the error width and is set to a half value of an absolute value of the curvature error that the two-sided probability becomes a predetermined percentage. As mentioned above, a negative value of the half value of lane width is set as the zero-order coefficient C0L of the left side boundary line. A positive value of the half value of lane width is set as the zero-order coefficient C0R of the right side boundary line. Zero is set as the first-order coefficients C1L, C1R of the left side boundary line and the right side boundary line. A half value of the curvature of the traveling course detected by the traveling state detection unit 11 is set as the second-order coefficients C2L, C2R of the left side boundary line and the right side boundary line.

The region estimation unit 14 calculates the left side boundary line YL_M and the right side boundary line YR_M of the middle probability region using the next equation.

YL_M(X)=C0L+C1L×X+(C2L−ΔC)×X²

YR_M(X)=C0R+C1R×X+(C2R+ΔC)×X² (5)

<Adaptation Setting of Error Width ΔC>

Even if the same driver drives the same own vehicle, the standard deviation of the curvature error due to steering fluctuation changes according to the traveling state of the own vehicle (especially speed of the own vehicle). An example of change of the standard deviation due to the speed of the own vehicle is shown in FIG. 14. FIG. 14 shows the standard deviation of the curvature error, the absolute value of the curvature error that the two-sided probability becomes 10% (two-sided 10% point), and the absolute value of the curvature error that the two-sided probability becomes 5% (two-sided 5% point), for each speed region. As shown in this figure, as the speed increases, the steering fluctuation decreases, the standard deviation decreases, and the two-sided 10% point and the two-sided 5% point decrease.

Then, the region estimation unit 14 changes the error width ΔC according to the speed of the own vehicle. For example, the region estimation unit 14 decreases the error width ΔC as the speed of the own vehicle increases. By referring to an error width setting data in which a relationship between the speed of the own vehicle and the error width ΔC is preliminarily set, the region estimation unit 14 calculates the error width ΔC corresponding to the current speed of the own vehicle. For example, data of the two-sided 5% point is used for the error width ΔC of curvature for estimation of the high probability region, and data of the two-sided 10% point is used for the error width ΔC of curvature for estimation of the middle probability region.

It was explained that the above-mentioned “filter value” of the yaw rate of the own vehicle corresponds to the curvature of the traveling lane. However, if a low pass filter processing with an appropriate time constant according to the speed of the own vehicle is performed, a phase delay (time lag) is caused in the “filter value.” Since this time lag is large such as about 5 to 20 seconds, it is unsuitable to use the “filter value” for calculation of the curvature of the traveling course. Although the “filter value” plotted in FIG. 10 does not have delay to the “raw value”, this is because time is advanced and plotted by the time delay for explanation, but actually, there is the time lag.

On the other hand, in order to estimate the difference of the steering fluctuation due to the difference of driver, the filter value of the curvature of the traveling course can be used. For example, the region estimation unit 14 may calculate a filter value obtained by performing a low pass filter processing to the curvature of the traveling course; calculate a deviation between the filter value, and the curvature of the traveling course which is delayed by a time delay due to the low pass filter processing, as a curvature error; calculate a standard deviation of the curvature error, based on a time series data of the curvature error; and calculate the error width ΔC, based on the standard deviation. For calculation of the standard deviation, well-known method, such as calculating a mean square error of the time series data of the curvature error, is used. By referring to an error width setting data in which a relationship between the standard deviation and the error width ΔC is preliminarily set, the region estimation unit 14 calculates the error width ΔC corresponding to the current standard deviation.

Also in this case, the region estimation unit 14 may calculate the standard deviation for each speed region as shown in FIG. 14, store data of the standard deviation for each speed region to the storage apparatus 91, and read the standard deviation corresponding to the current speed of the own vehicle from data.

<Adjustment of High Probability Region and Middle Probability Region>

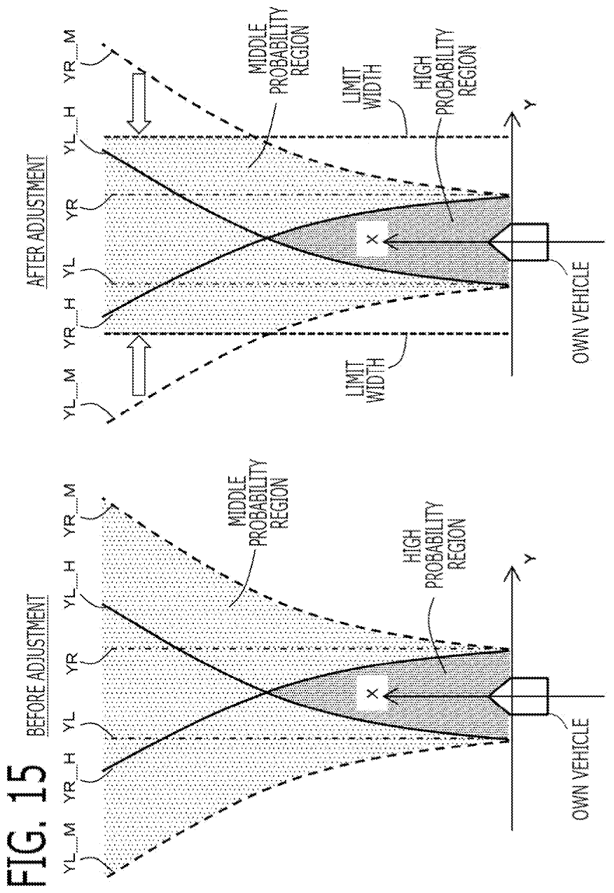

An example of region adjustment is shown in FIG. 15. A case where the own vehicle is going straight and the estimated lane is the straight line is exemplified. In the left side of FIG. 15, the high probability region and the middle probability region before adjustment are shown, the error width of curvature ΔC for estimation of the high probability region is set to the half value of the two-sided 5% point of a certain standard deviation, for example, and the error width of curvature ΔC for estimation of the middle probability region is set to the half value of the two-sided 10% point, for example. The middle probability region before adjustment expands even to the whole region of the adjacent lanes in the distant place. If determination of the preceding vehicle determination unit 15 described below is performed using this kind middle probability region, even if the front vehicle changes lane to the adjacent lane, the front vehicle is determined as the preceding vehicle. Accordingly, it is necessary to make the middle probability region not become wide too much.

Then, as an adjustment example is shown in the right side of FIG. 15, the region estimation unit 14 limits the middle probability region so that the middle probability region does not expand more than a limit width from the estimated lane in the lateral direction. The limit width is set to the half value of the lane width or less, for example.

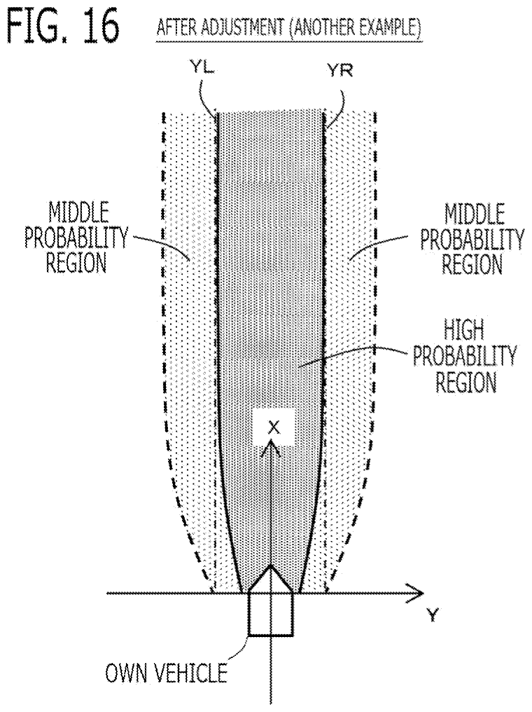

Alternatively, as a different example of adjustment is shown in FIG. 16, if the sensor is special, the high probability region and the middle probability region may be set so as to bring a good determination result of the preceding vehicle considering characteristics of the special sensor, based on the estimated lane.

1-5. Preceding Vehicle Determination Unit 15

In the step S45 of FIG. 3, the preceding vehicle determination unit 15 executes a preceding vehicle determination processing (a preceding vehicle determination step) that determines whether the front vehicle is a preceding vehicle which is traveling forward in the traveling lane where the own vehicle is traveling, based on the position history of the front vehicle, the high probability region, and the middle probability region.

In the present embodiment, when a part of the position history of the front vehicle is outside the middle probability region and the high probability region, and a part of the position history of the front vehicle which is newer than the part of the position history of the front vehicle which is outside the middle probability region and the high probability region is not inside the high probability region, the preceding vehicle determination unit 15 determines that the front vehicle is not the preceding vehicle. And, when a part of the position history of the front vehicle is outside the middle probability region and the high probability region, and a part of the position history of the front vehicle which is newer than the part of the position history of the front vehicle which is outside the middle probability region and the high probability region is inside the high probability region, the preceding vehicle determination unit 15 determines that the front vehicle is the preceding vehicle. When a part of position history of the front vehicle is not outside the middle probability region and the high probability region, and a part of the position history of the front vehicle is inside the high probability region, the preceding vehicle determination unit 15 determines that the front vehicle is the preceding vehicle.

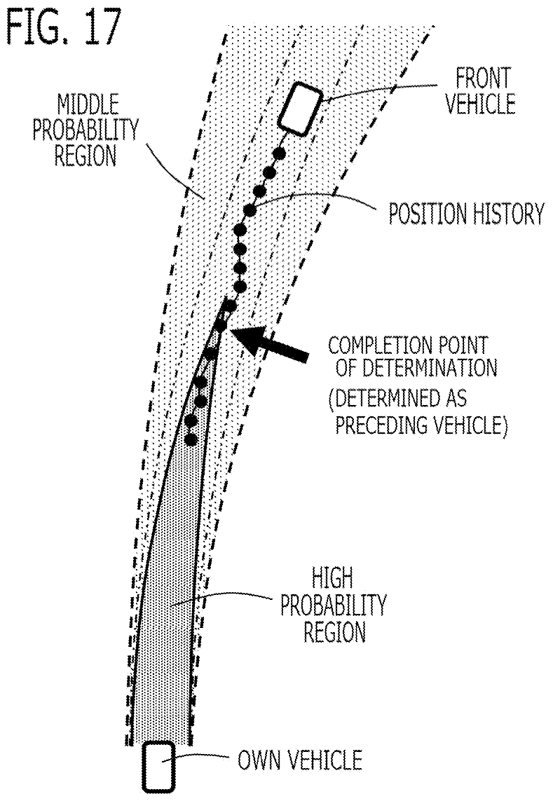

This will be explained using examples of FIG. 17 to FIG. 20. An example of FIG. 17 is a case where the front vehicle is traveling the traveling lane of the own vehicle continuously. In this case, since a part of the position history of the front vehicle does not become outside the middle probability region and the high probability region, but apart of the position history of the front vehicle becomes inside the high probability region, it is determined with good accuracy that the front vehicle is the preceding vehicle.

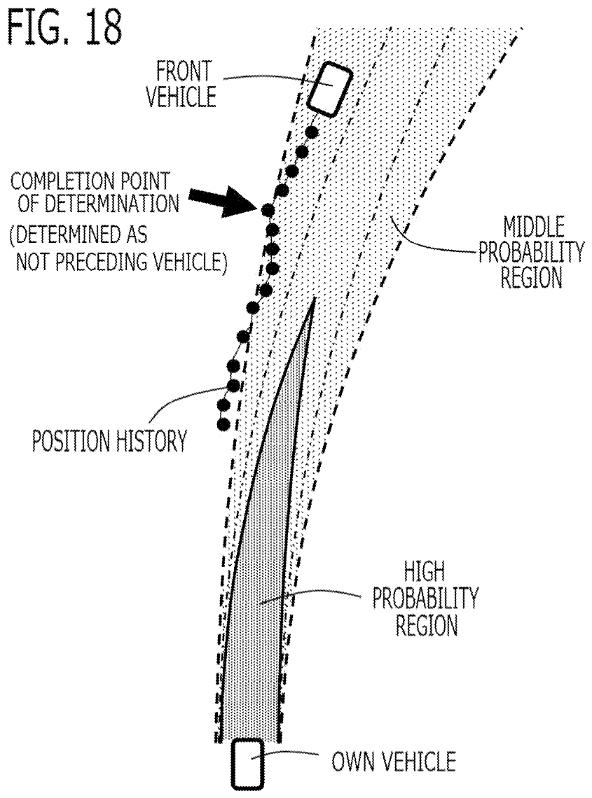

An example of FIG. 18 is a case where the front vehicle is traveling the adjacent lane on the left side of the traveling lane of the own vehicle continuously. In this case, since a part of the position history of the front vehicle becomes outside the middle probability region and the high probability region, and a part of the position history of the front vehicle which is newer than the part of the position history of the front vehicle which is outside the middle probability region and the high probability region does not become inside the high probability region, it is determined with good accuracy that the front vehicle is not the preceding vehicle.

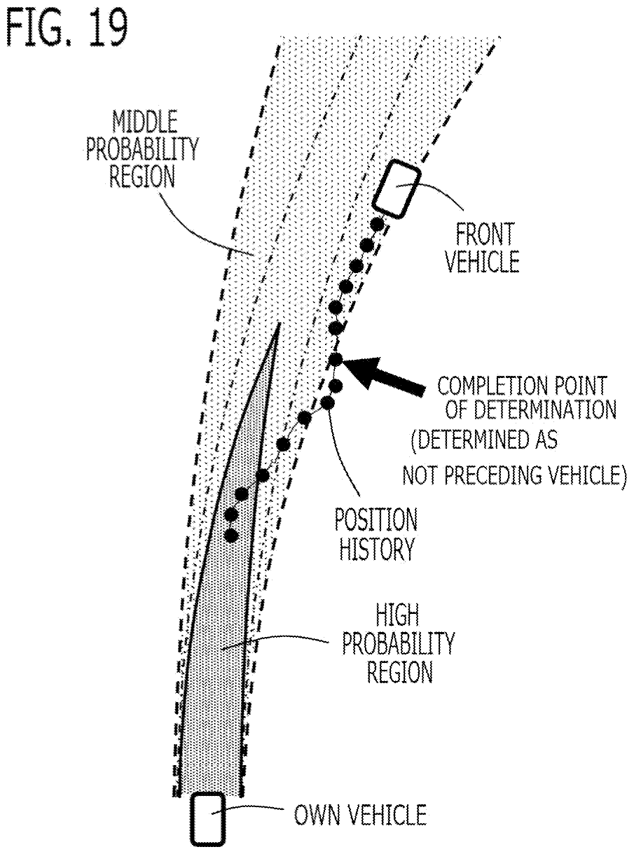

An example of FIG. 19 is a case where the front vehicle was traveling the traveling lane of the own vehicle in the past, but changed lane to the adjacent lane of right side halfway, and is traveling the adjacent lane currently. In this case, since after changing lane to the adjacent lane, a part of the position history of the front vehicle becomes outside the middle probability region and the high probability region, and a part of the position history of the front vehicle which is newer than the part of the position history of the front vehicle which is outside the middle probability region and the high probability region does not become inside the high probability region, it is determined with good accuracy that the front vehicle is not the preceding vehicle.

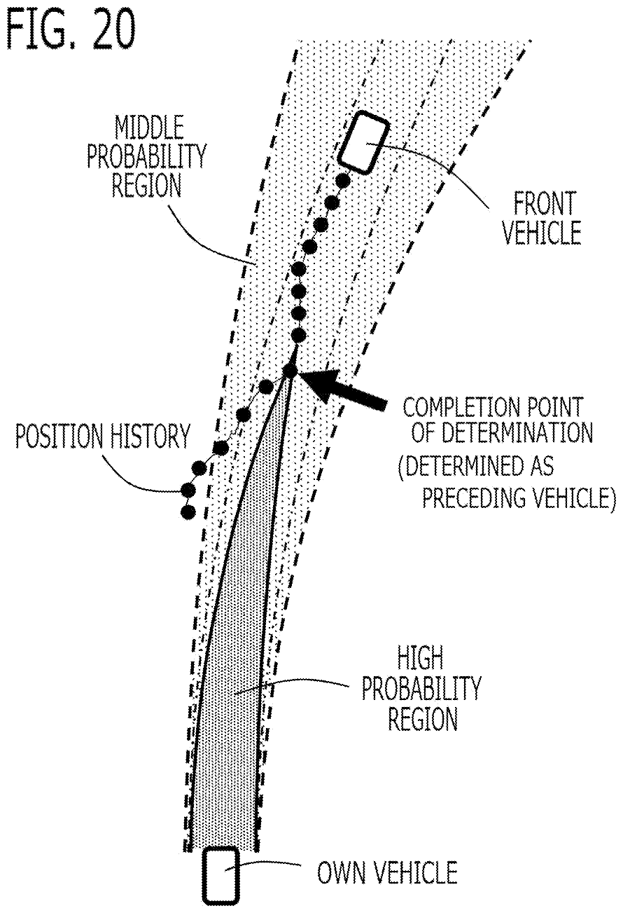

An example of FIG. 20 is a case where the front vehicle was traveling the adjacent lane of left side in the past, but changed lane to the traveling lane of the own vehicle halfway, and is traveling the traveling lane of the own vehicle currently. In this case, since before changing lane to the traveling lane of the own vehicle, a part of the position history of the front vehicle becomes outside the middle probability region and the high probability region, but a part of the position history of the front vehicle which is newer than the part of the position history of the front vehicle which is outside the middle probability region and the high probability region becomes inside the high probability region, it is determined with good accuracy that the front vehicle is the preceding vehicle.

As described above, by determining using the high probability region and the middle probability region, even when the position history of the front vehicle is changing complicatedly by the lane change, it can be determined with good accuracy whether or not the front vehicle is the preceding vehicle.

<Repeated Determination from Newer History Number>

In order to perform this kind determination, in the present embodiment, the preceding vehicle determination unit 15 sets a determination position in order from a newer position about the position history of the front vehicle. When the determination position is inside the high probability region, the preceding vehicle determination unit 15 determines that the front vehicle is the preceding vehicle and ends determination. When the determination position is outside the middle probability region and the high probability region, the preceding vehicle determination unit 15 determines that the front vehicle is not the preceding vehicle and ends determination. When the determination position is outside the high probability region and is inside the middle probability region, the preceding vehicle determination unit 15 sets an older position by one as the determination position and repeatedly performs determination.

By this processing, in the example of FIG. 17, the determination is performed from a newer position history in order, since the position history is outside the high probability region and is inside the middle probability region, determination is continued. Since the arrowed position history of FIG. 17 became inside the high probability region, it is determined that the front vehicle is the preceding vehicle, and the determination is ended. In the example of FIG. 18, the determination is performed from a newer position history in order, since the position history is outside the high probability region and is inside the middle probability region, determination is continued. Since the arrowed position history of FIG. 18 became outside the middle probability region and the high probability region, it is determined that the front vehicle is not the preceding vehicle, and the determination is ended.

In the example of FIG. 19, the determination is performed from a newer position history in order, since the position history is outside the high probability region and is inside the middle probability region, determination is continued. Since the arrowed position history of FIG. 19 became outside the middle probability region and the high probability region, it is determined that the front vehicle is not the preceding vehicle, and the determination is ended. Accordingly, although the old position history is inside the high probability region, it can be determined with good accuracy without being affected by it.

In the example of FIG. 20, the determination is performed from a newer position history in order, since the position history is outside the high probability region and is inside the middle probability region, determination is continued. Since the arrowed position history of FIG. 20 became inside the high probability region, it is determined that the front vehicle is the preceding vehicle, and the determination is ended. Accordingly, although the old position history is outside the middle probability region and the high probability region, it can be determined with good accuracy without being affected by it.

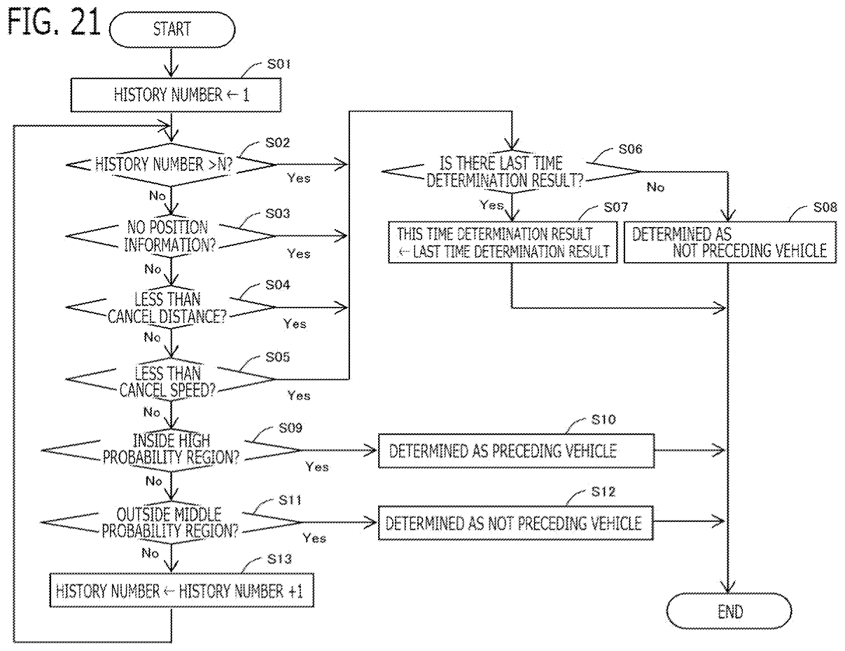

For example, this processing is realizable by processing of the flowchart of FIG. 21. Processing of FIG. 21 is repeatedly performed at a calculation period. When a plurality of front vehicles are detected, processing of FIG. 21 is performed for each front vehicle.

In the step S01, the preceding vehicle determination unit 15 sets the history number for determination (hereinafter, referred to as a determination history number) to 1 which is the newest history number, and advances to the step S02.

In the step S02, the preceding vehicle determination unit 15 determines whether the determination history number is larger than the maximum number N. When determining that it is larger, it advances to the step S06, and when determining that it is not larger, it advances to the step S03. When the determination history number becomes larger than the maximum number N, since determination was performed about all the position history, the determination is ended.

In the step S06, the preceding vehicle determination unit 15 determines whether the determination result of the preceding vehicle of the last time calculation period exists about the same front vehicle. When determining that the determination result of the preceding vehicle exists, it advances to the step S07, and when determining that the determination result of the preceding vehicle does not exist, it advances to the step S08. The determination result of the preceding vehicle is a determination result of whether the front vehicle is the preceding vehicle.

In the step S07, the preceding vehicle determination unit 15 sets the determination result of the preceding vehicle of the last time calculation period as the determination result of the preceding vehicle of this time calculation period, maintains the last time determination result, and ends a series of processing. On the other hand, in the step S08, the preceding vehicle determination unit 15 determines that the front vehicle is not the preceding vehicle, and ends a series of processing.

In the step S03, the preceding vehicle determination unit 15 determines whether the position information of the front vehicle is stored at the determination history number. When determining that it is not stored, it advances to the step S06, and when determining that it is stored, it advances to the step S04. Since the front vehicle detected comparatively newly does not have the old position history, the determination is ended.

By the way, depending on type of the periphery monitoring apparatus 20 (a certain kind of millimeter wave radar, and a certain kind of optical camera), due to an interference due to reflection of the radio wave from other obstacles, an influence that the front vehicle is hidden behind other objects, and the like, the position of the front vehicle may become undetectable temporary (for example, from one period to several periods, from several milliseconds to several seconds). In this case, since apart of the position history is missing, the determination is ended in the step S03. However, since the position history older than the missing time point exists, processing of step S03 may be changed as follows. That is to say, in the step S03, the preceding vehicle determination unit 15 may determine whether the position information of the front vehicle is stored at the determination history number. When determining that it is not stored, it may advance to the step S13, and when determining that it is stored, it may advance to the step S04. The processing of the determination history number at which the position history is missing is skipped, it advances to a subsequent determination history number, and the determination processing can be continued.

In the step S04, the preceding vehicle determination unit 15 determines whether the position in the front direction of the determination history number is less than a cancel distance. When determining that it is less than the cancel distance, it advances to the step S06, and when determining that it is not less than the cancel distance, it advances to the step S05. When the position in the front direction of the front vehicle becomes very close to the own vehicle, or becomes behind the own vehicle, since it is not necessary to perform the preceding vehicle determination, the determination is ended.

In the step S05, the preceding vehicle determination unit 15 determines whether the ground speed in the front direction of the front vehicle of the determination history number is less than a cancel speed. When determining that it is less than the cancel speed, it advances to the step S06, and when determining that it is not less than the cancel speed, it advances to the step S09. When the ground speed in the front direction of the front vehicle becomes slow, or is the speed of the oncoming vehicle, since it is not necessary to perform the preceding vehicle determination, the determination is ended.

One or both of the cancel determination of the step S04 and the cancel determination of the step S05 may not be performed, and a cancel determination other than the step S04 and the step S05 may be added.

In the step S09, the preceding vehicle determination unit 15 determines whether the position of the front vehicle of the determination history number is inside the high probability region. When determining that it is inside the high probability region, it advances to the step S10, and when determining that it is not inside the high probability region, it advances to the step S11. In the step S10, since the position of the front vehicle of the determination history number is inside the high probability region, the preceding vehicle determination unit 15 determines that the front vehicle is the preceding vehicle, and ends a series of determination processing.

In the step S11, the preceding vehicle determination unit 15 determines whether the position of the front vehicle of the determination history number is outside the middle probability region. When determining that it is outside the middle probability region, it advances to the step S12, and when determining that it is not outside the middle probability region, it advances to the step S13. In the step S12, since the position of the front vehicle of the determination history number is outside the middle probability region and the high probability region, the preceding vehicle determination unit 15 determines that the front vehicle is not the preceding vehicle, and ends a series of determination processing.

In the step S13, since the position of the front vehicle of the determination history number is outside the high probability region and is inside the middle probability region, the preceding vehicle determination unit 15 increases the determination history number by one, and sets the determination history number to the older history number by one, after that, returns to the step S02, and repeatedly performs the determination.

<Selection of One Preceding Vehicle>

When a plurality of front vehicles (preceding vehicle) which are determined as the preceding vehicle exist, the preceding vehicle determination unit 15 selects one vehicle from the plurality of preceding vehicles as the final preceding vehicle. For example, the preceding vehicle determination unit 15 selects a vehicle whose position in the front direction is closest to the own vehicle from the plurality of preceding vehicles as the final preceding vehicle.

1-6. Driving Control Unit 16

In the step S46 of FIG. 3, the driving control unit 16 performs automatic driving or driving support of the own vehicle based on the position of the preceding vehicle. As the automatic driving, various kinds of automatic driving which considers the preceding vehicle is included, for example, there are a lane change considering the preceding vehicle, a vehicle distance control with the preceding vehicle, a contact avoidance driving with the preceding vehicle, a following driving to the preceding vehicle, and the like. As the driving support, various kinds of driving support which considers the preceding vehicle is included, for example, although overlapping with the automatic driving, there are a vehicle distance control with the preceding vehicle, an information to the driver of various information regarding the preceding vehicle, such as rear-end collision warning and caution, and the like.

The driving control unit 16 transmits command generated based on the preceding vehicle to the steering apparatus 24, the power apparatus 25, the braking apparatus 26, the user interface apparatus 27, and the like, controls vehicle motion, and informs information necessary for the user. The steering apparatus 24 is an apparatus which controls the steering angle of wheel. The power apparatus 25 is an apparatus which controls the power source of wheel, such as the engine and the motor. The braking apparatus 26 is an apparatus which controls the brake of wheel. The user interface apparatus 27 is an apparatus, such as the display, the input device, the loudspeaker, and the microphone.

### 2. Embodiment 2

Next, the preceding vehicle determination system 1 according to Embodiment 2 will be explained. The explanation for constituent parts the same as those in Embodiment 1 will be omitted. The basic configuration of the preceding vehicle determination system 1 according to the present embodiment is the same as that of Embodiment 1. Embodiment 2 is different from Embodiment 1 in that the region estimation unit 14 uses lane boundary line shapes of the traveling lane of the own vehicle as the traveling state of the own vehicle.

In the present embodiment, the traveling state detection unit 11 detects a region of the traveling lane of the own vehicle as the traveling state of the own vehicle. For example, the traveling state detection unit 11 detects lane boundary line shapes of the traveling lane of the own vehicle, and detects the region of the traveling lane of the own vehicle based on the lane boundary line shapes. The traveling state detection unit 11 may detect roadside objects, such as a guardrail, a pole, a road shoulder, and a wall, not limited to the lane boundary line, and detect the region of the traveling lane of the own vehicle based on the roadside object.

The traveling state detection unit 11 detects the lane boundary lines of the traveling lane and the roadside object, based on the detection result of the periphery monitoring apparatus 20, such as the camera and the radar. For example, by performing image processing to the picture obtained by imaging the front by the optical camera, the lane boundary line and the roadside object are detected. The lane boundary line is detected from the points that the reflection luminance of the laser radar is high. Alternatively, the roadside object is detected by the radar. The traveling state detection unit 11 calculates positions of the lane boundary line and the roadside object on the own vehicle coordinate system, and calculates the region of the traveling lane of the own vehicle on the own vehicle coordinate system.

Alternatively, by referring to the road map data used in the navigation apparatus and the like, the traveling state detection unit 11 may determine the current traveling lane of the own vehicle based on the current position of the own vehicle, obtain a shape of the current traveling lane of the own vehicle from the road map data, and detect the region of the traveling lane. The road map data may be stored in the storage apparatus 91 of the information processing apparatus 10, and may be obtained from an external server by the wireless communication.

<Region Setting by Lane Boundary Line Shape>

In the following, a case where the white line is detected will be explained. The traveling state detection unit 11 detects the lane boundary line shape of the traveling lane by performing curve approximation using an equation expressing curve shape, such as a clothoid curve. In the following, a case where approximation is performed using a second-order polynomial of the next equation similar to the equation (3) and the like is explained.

YwL(X)=Cw0L+Cw1L×X+Cw2L×X²

YwR(X)=Cw0R+Cw1R×X+Cw2R×X² (6)

Herein, the first equation of the equation (6) is an approximation equation of the lane boundary line shape of left side, and the position YwL in the lateral direction of the lane boundary line shape of left side at each position X in the front direction is calculated. The second equation of the equation (6) is an approximation equation of the lane boundary line shape of right side, and the position YwR in the lateral direction of the lane boundary line shape of right side at each position X in the front direction is calculated. Each order coefficient Cw0L to Cw2R is changed and approximated in accordance with the lane boundary line shape.

As an index which expresses how far the lane boundary line shape calculated by the equation (6) is effective in the front direction from the own vehicle, an effective distance VL of left side and an effective distance VR of right side are calculated.

The region estimation unit 14 detects a region interposed between the calculated left side lane boundary line and the right side lane boundary line, as the region of the traveling lane of the own vehicle. The region of the traveling lane of the own vehicle corresponds to the estimated lane of Embodiment 1.

However, the own vehicle does not always pass inside the region of the traveling lane. If it is a short distance, the own vehicle passes inside the region of the traveling lane almost certainly. However, as it becomes a longer distance, the own vehicle may not pass inside the region of the traveling lane.

As a main cause, a fitting error and an extrapolation error due to change of actual lane boundary line shape are mentioned, for example. Although the traveling state detection unit 11 performs curve approximation of lane boundary line shape by the least square method (or robust estimation like RANSAC and LMedS) based on point group corresponding to the detected lane boundary line, occurrence of approximate error is unavoidable. Although the approximate error is small in a range where the point group exists, the approximate error becomes large in a range (extrapolation range) where the point group does not exist, and the approximate error becomes larger as it becomes farther from the existence range of the point group.

Accordingly, even if the own vehicle travels without the lane change, the region of the detected traveling lane deviates from the region of the actual traveling lane, as it becomes farther from the detection range of the lane boundary line (the point group).

Since this kind deviation is unavoidable, as mentioned above, the effective distance VL of left side and the effective distance VR of right side each of which expresses how far the lane boundary line shape is effective are calculated. The effective distance VL of left side and the effective distance VR of right side are set corresponding to the existence range of the point group of the lane boundary line used for the curve approximation.

Especially, an overlapping range of the effective distance VL of left side and the effective distance VR of right side, that is, a range corresponding to an effective distance VF for setting which is the shorter one of the effective distance VL of left side and the effective distance VR of right side becomes a range where the approximate error of the lane boundary line shape becomes small.

Then, the region estimation unit 14 estimates the high probability region and the middle probability region, based on the lane boundary line shape of the traveling lane. In the present embodiment, the region estimation unit 14 sets the high probability region corresponding to a range which is interposed between the lane boundary line shape of left side YwL and the lane boundary line shape of right side YwR and in which the original data (in this example, the point group) of the lane boundary line used for the curve approximation exists. And, the region estimation unit 14 sets the middle probability region to a range which is interposed between the lane boundary line shape of left side YwL and the lane boundary line shape of right side YwR and which is other than the high probability region.

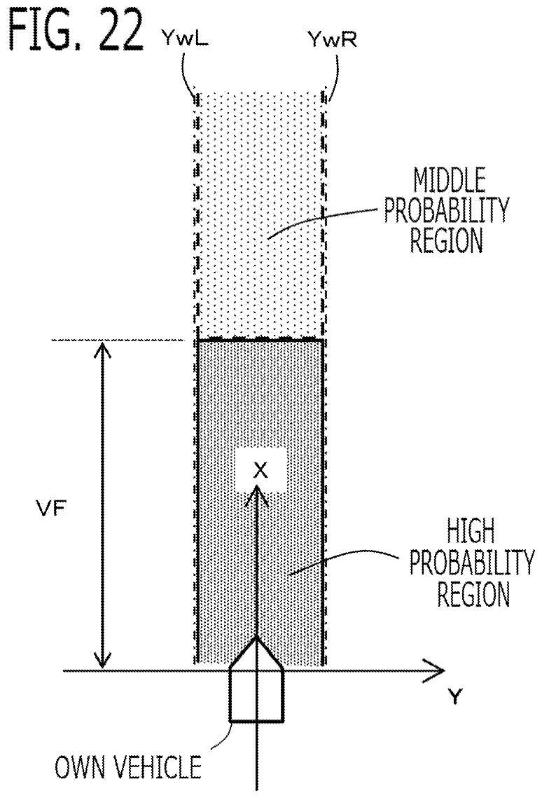

As shown in FIG. 22, the region estimation unit 14 sets the high probability region to a range which is interposed between the lane boundary line shape of left side YwL and the lane boundary line shape of right side YwR and which is from 0 to the effective distance VF for setting in the front direction. And, the region estimation unit 14 sets the middle probability region to a range which is interposed between the lane boundary line shape of left side YwL and the lane boundary line shape of right side YwR and which is farther than the effective distance VF for setting in the front direction.

Depending on performance of the camera or the radar (for example, if the pixel number of the viewing angle of the camera is insufficient), and state of the road (for example, when a large size vehicle and the like which travels the own-lane or the adjacent lanes hide the lane boundary line), if the effective distance VF for setting is set to the overlapping range between the effective distance VL of left side and the effective distance VR of right side, the effective distance may become short practically. In such case, considering an index which expresses a goodness of fitting, a consistency of right and left lane boundary line shapes (a range where right and left are parallel, a range where the lane width is appropriate), or the like, the effective distance VF for setting may be set.

<Adjustment of High Probability Region and Middle Probability Region>

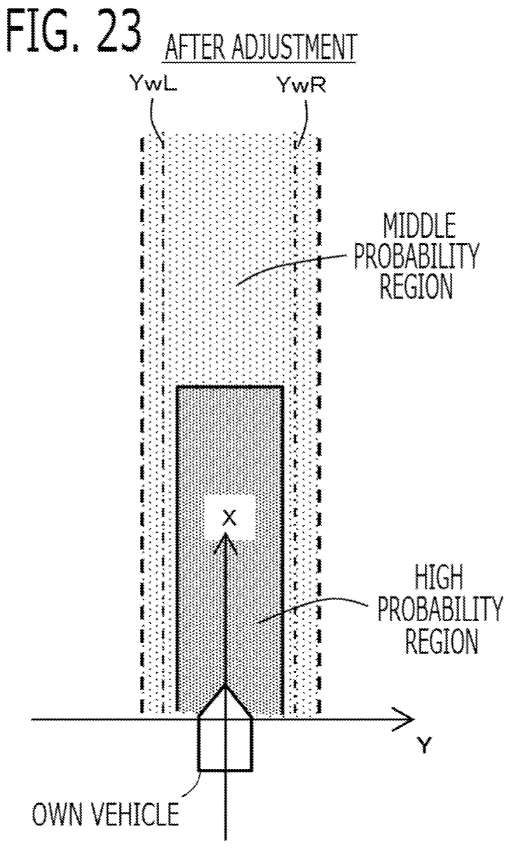

Adjustment of the high probability region and the middle probability region may be performed. For example, as shown in FIG. 23 and the next equation, the region estimation unit 14 may set the high probability region to a range which is interposed a lane boundary line shape YwL_H after adjustment obtained by changing the lane boundary line shape of left side YwL to right side, and a lane boundary line shape YwR_H after adjustment obtained by changing the lane boundary line shape of right side YwR to left side, and which is from 0 to the effective distance VF for setting in the front direction. And, the region estimation unit 14 may set the middle probability region to a range which is interposed between a lane boundary line shape YwL_M after adjustment obtained by changing the lane boundary line shape of left side YwL to left side, and a lane boundary line shape YwR_M after adjustment obtained by changing the lane boundary line shape of right side YwR to right side, and which is other than the high probability region.

YwL_H(X)=(Cw0L+ΔC0L)+(Cw1L+ΔC1L)×X+(Cw2L+ΔC2L)×X²

YwR_H(X)=(Cw0R−ΔC0R)+(Cw1R−ΔC1R)×X+(Cw2R−ΔC2R)×X²

YwL_M(X)=(Cw0L−ΔC0L)+(Cw1L−ΔC1L)×X+(Cw2L−ΔC2L)×X²

YwR_M(X)=(Cw0R+ΔC0R)+(Cw1R+ΔC1R)×X+(Cw2R+ΔC2R)×X² (7)

Each correction coefficient ΔC0L, ΔC1L, ΔC2L, ΔC0R, ΔC1R, ΔC2R may be changed according to setting of the high probability region, and setting of the middle probability region. Each correction coefficient ΔC0L to ΔC2R may be changed according to the range from 0 to the effective distance VF for setting, and the range larger than the effective distance VF for setting.

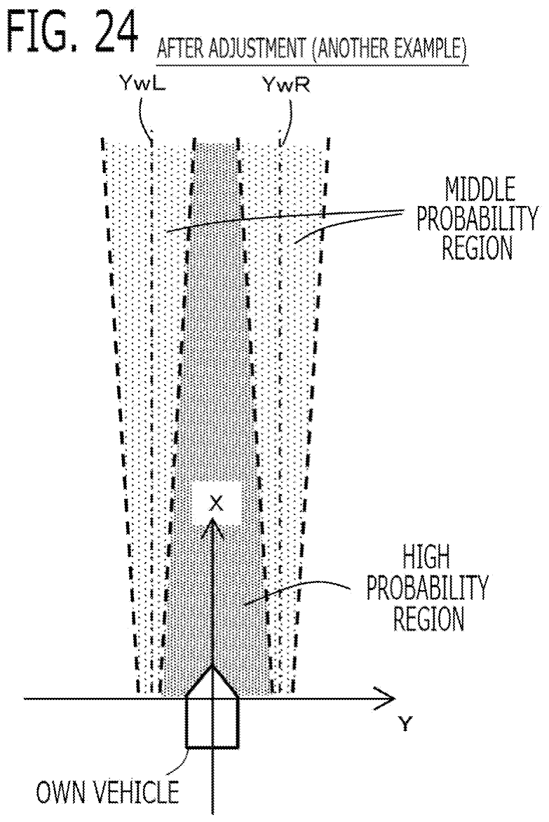

A case where the road map data mentioned above is used will be explained supplementary. If there is an error in the position, the azimuth, and the like of the current own vehicle, when the current traveling lane of the own vehicle is determined with reference to the road map data based on the position and the like of the current own vehicle, a determination error may occur. Considering the estimation error of the position, the azimuth, and the like of the current own vehicle, the high probability region and the middle probability region may be adjusted. FIG. 24 shows the high probability region and the middle probability region after adjustment. This kind adjustment amount may be changed according to an index of precision of position detection. For example, as the index of precision, usage of either of FIX solution or FLOAT solution in the RTK positioning of GNSS, an elapsed time after becoming dead reckoning, or an element value of an error covariance matrix in Kalman filter are mentioned.

### 3. Embodiment 3

Next, the preceding vehicle determination system 1 according to Embodiment 3 will be explained. The explanation for constituent parts the same as those in Embodiment 1 will be omitted. The basic configuration of the preceding vehicle determination system 1 according to the present embodiment is the same as that of Embodiment 1. In the present embodiment, a case where the driving control unit 16 performs vehicle distance control is explained especially in detail.

<Vehicle Distance Control>

The driving control unit 16 controls a vehicle distance between the preceding vehicle and the own vehicle. In the vehicle distance control, without interposing the accelerator operation and the brake operation of the driver, the vehicle speed is controlled so as to maintain appropriate the vehicle distance between the own vehicle and the preceding vehicle. Alternatively, mainly, during traffic congestion, in the vehicle distance control, the vehicle distance is maintained appropriately by performing vehicle start, acceleration, deceleration, or stop of the own vehicle according to vehicle start, acceleration, deceleration, or stop of the preceding vehicle, without interposing the accelerator operation and the brake operation of the driver; and the handle operation (or steering torque assistance that makes the driver easily perform the handle operation) is performed so as to trace the traveling course of the preceding vehicle, without interposing the handle operation of the driver almost.

<Preceding Vehicle Determination Considering Vehicle Distance Control>

The preceding vehicle determined by the preceding vehicle determination unit 15 becomes an object to which the vehicle distance control is performed. Accordingly, if a distant front vehicle is determined as the preceding vehicle, an adverse influence may be given on the vehicle distance control. Therefore, it is desirable to exclude the distant front vehicle from the object of the preceding vehicle determination, and to include the front vehicle of appropriate front distance in the object of the preceding vehicle determination.

In the present embodiment, the preceding vehicle determination unit 15 determines whether the front vehicle is the preceding vehicle using a position history which becomes inside a determination standard distance which is set corresponding to the vehicle distance controlled by the vehicle distance control among the position history of the front vehicle. The other part is constituted similar to Embodiment 1.

According to this configuration, since the determination standard distance is set corresponding to the vehicle distance controlled by the vehicle distance control, the position history of the distant front vehicle unsuitable as the object of the vehicle distance control is excluded from the object of the preceding vehicle determination, and the position history of the front vehicle with the front distance appropriate as the object of the vehicle distance control is included in the object of the preceding vehicle determination. Accordingly, the front vehicle determined as the preceding vehicle can be made appropriate to the vehicle distance control.

On the other hand, if the determination standard distance is set small too much, and it is determined whether it is the preceding vehicle using a position history of the history numbers too close to the own vehicle (or too old), an uncomfortable feeling is given to the driver of the own vehicle and the performance of vehicle distance control is deteriorated. For example, even though the front vehicle changed lane and departed from the traveling lane of the own vehicle, cancellation from the preceding vehicle is delayed, the own vehicle does not accelerate by the vehicle distance control, and this causes the uncomfortable feeling. Alternatively, even though the front vehicle which was traveling the adjacent lane interrupted the own-lane suddenly, determination that the front vehicle is the preceding vehicle is delayed, although the front vehicle is approaching just ahead of the own vehicle, the vehicle distance control does not work, the own vehicle does not decelerate, and this causes the uncomfortable feeling.

In the vehicle distance control, generally, an index of “inter vehicle time” is used as an index of the appropriate vehicle distance. The inter vehicle time is a time needed for the own vehicle to reach at a position of the front vehicle of a certain time point. That is to say, the inter vehicle time is a value obtained by dividing the front distance of the front vehicle by the speed of the own vehicle. Since the speed of the front vehicle and the speed of the own vehicle finally coincide by the vehicle distance control, the inter vehicle time may be a value obtained by dividing the front distance of the front vehicle by the speed of the front vehicle.

Using this kind index of the inter vehicle time, for example, the vehicle distance with the preceding vehicle is controlled so as to be a vehicle distance that the inter vehicle time becomes 2 seconds. But, if it is made to coincide with the inter vehicle time strictly, the vehicle distance becomes zero at vehicle stop, and the vehicle distance become large too much compared with an interval of the driver at high vehicle speed. Accordingly, it is not made to always coincide with the inter vehicle time, some adjustment is performed usually.

In the vehicle distance control using the inter vehicle time as the index, if the preceding vehicle determination is performed, and a distance which corresponds to about 1 time to 2 times of the inter vehicle time is set as the above-mentioned determination standard distance, a good result of few uncomfortable feeling is obtained at normal traveling. When the relative speed between the own vehicle and the front vehicle is zero, a distance corresponding to about 1 time of the inter vehicle time is set as the determination standard distance. And, as the relative speed becomes larger from zero in a negative side (approaching side), the determination standard distance is increased. Accordingly, the uncomfortable feeling in the traveling state when the speed difference between vehicles is large is not caused, and further good result can be obtained. Alternatively, a plurality of drivers actually evaluate a plurality of setting values of the determination standard distance, and a determination standard distance with good evaluation result may be set as the final setting value.

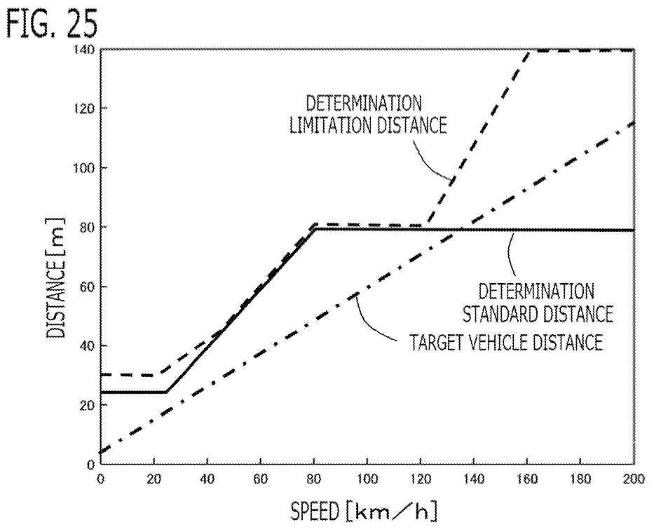

FIG. 25 shows an example of the determination standard distance set in this way. The horizontal axis is the speed of the own vehicle, and the vertical axis is the determination standard distance. The target vehicle distance used for the vehicle distance control is shown in FIG. 25 as reference. In a low vehicle speed region where the speed of the own vehicle becomes lower than a predetermined speed (in this example, 25 km/h), the determination standard distance is set to a constant value larger than zero and does not become zero. In a high vehicle speed region where the speed of the own vehicle becomes higher than a predetermined speed (in this example, 80 km/h), the determination standard distance is set to a constant value, and does not become large too much according to the increase in speed. In a middle vehicle speed region (in this example, from 25 km/h to 80 km/h) between the low vehicle speed region and the high vehicle speed region, the determination vehicle distance is increased as the speed of the own vehicle increases.

A determination limitation distance described below is shown in FIG. 25. Since the determination limitation distance is used for a processing which forcibly terminates the preceding vehicle determination, it is set to a value greater than or equal to the determination standard distance.

In the vehicle distance control in which the driver can switch setting of the target vehicle distance, the setting value of the determination vehicle distance may be changed according to the setting value of the target vehicle distance. For example, the target vehicle distance is switched to a setting corresponding to the inter vehicle time of 1 second, or is switched to a setting corresponding to the inter vehicle time of 3 seconds. The uncomfortable feeling of the driver can be further reduced.

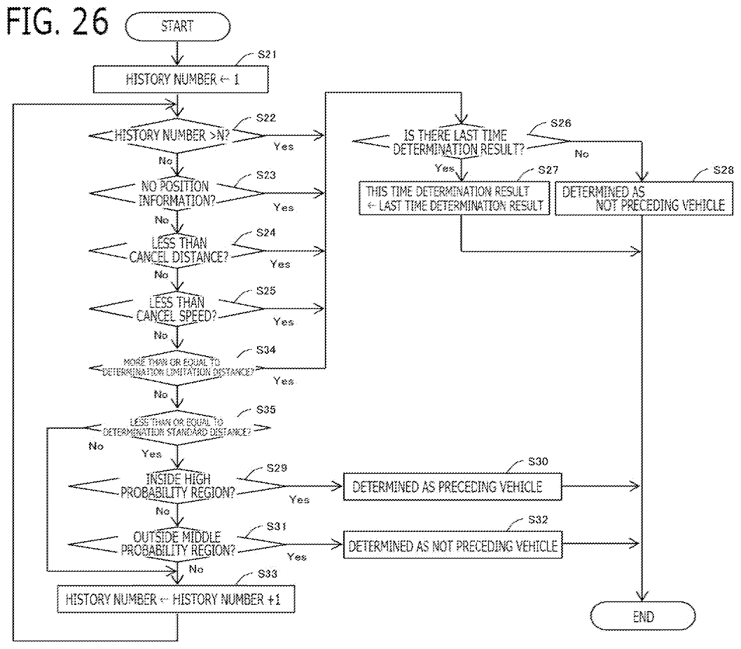

For example, the processing of the preceding vehicle determination unit 15 according to Embodiment 3 can be realized by processing of the flowchart of FIG. 26. The processing of FIG. 26 is repeatedly performed at a calculation period. When a plurality of front vehicles are detected, processing of FIG. 26 is performed for each front vehicle.

Since the processing from step S21 to the step S28 is the same as the step S01 to the step S08 of FIG. 21 of Embodiment 1, explanation is omitted. Since processing from the step S29 to the step S33 is the same as the step S09 to the step S13 of FIG. 21 of Embodiment 1, explanation is omitted.

In the present embodiment, in the step S25, the preceding vehicle determination unit 15 determines whether the ground speed in the front direction of the front vehicle of the determination history number is less than a cancel speed. When determining that it is less than the cancel speed, it advances to the step S26, and when determining that it is not less than the cancel speed, it advances to the step S34 which is particular to the present embodiment.

In the step S34, the preceding vehicle determination unit 15 determines whether the position in the front direction of the front vehicle of the determination history number is greater than or equal to the determination limitation distance. When determining that it is greater than or equal to the determination limitation distance, it advances to the step S26, and when determining that it is not greater than or equal to the determination limitation distance, it advances to the step S35. When it is determined that the position of the front vehicle of the determination history number (for example, 1) is greater than or equal to the determination limitation distance, and the comparatively new position of the front vehicle is too far for performing the vehicle distance control, the preceding vehicle determination is not performed, and the determination is ended.

Since accuracy of the preceding vehicle determination is usually deteriorated, as it becomes farther, the preceding vehicle determination of the distant front vehicle is not performed by determination of the determination limitation distance. However, if accuracy of the preceding vehicle determination is maintained even in the distant place, the step S34 may not be provided. Also if setting accuracy of the high probability region and the middle probability region is maintained, the step S34 may not be provided.

In the step S35, the preceding vehicle determination unit 15 determines whether the position in the front direction of the front vehicle of the determination history number is less than or equal to the determination standard distance. When determining that it is less than or equal to the determination standard distance, it advances to the step S29, and when determining that it is not less than or equal to the determination standard distance, it advances to the step S33. When the position of the front vehicle of the determination history number is less than or equal to the determination standard distance and is suitable for the preceding vehicle determination for the vehicle distance control, the preceding vehicle determination is performed in the step S29 to the step 32. When the position of the front vehicle of the determination history number is larger than the determination standard distance and is not suitable for the preceding vehicle determination for the vehicle distance control, the preceding vehicle determination is not performed, but it advances to the older determination history number by one, and the determination processing is continued.

In each of above embodiments, respective processing units 11 to 16 of the preceding vehicle determination system 1 are provided in the information processing apparatus 10, and are realized by the processing circuit provided in the information processing apparatus 10. However, each of these processing units 11 to 16 does not need to be realized by the dedicated information processing apparatus 10. For example, if the periphery monitoring apparatus 20, the own position detecting apparatus 21, or the driving condition detecting apparatus 22 is provided with processing circuits equivalent to the arithmetic processor 90, the storage apparatus 91, and the input and output circuit 92, all or a part of respective processing units 11 to 16 may be realized by the equivalent processing circuits provided in the periphery monitoring apparatus 20, the own position detecting apparatus 21, or the driving condition detecting apparatus 22.

Although the present disclosure is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations to one or more of the embodiments. It is therefore understood that numerous modifications which have not been exemplified can be devised without departing from the scope of the present disclosure. For example, at least one of the constituent components may be modified, added, or eliminated. At least one of the constituent components mentioned in at least one of the preferred embodiments may be selected and combined with the constituent components mentioned in another preferred embodiment.

### REFERENCE SIGNS LIST

1 Preceding Vehicle Determination System, 11 Traveling State Detection Unit, 12 Front Vehicle Position Detection Unit, 13 Position History Calculation Unit, 14 Region Estimation Unit, 15 Preceding Vehicle Determination Unit, 16 Driving Control Unit

1. A preceding vehicle determination system comprising at least one processor configured to implement:
a traveling state detection unit detector that detects a position and a traveling state of an own vehicle;
a front vehicle position detector that detects a position of a front vehicle located in front of the own vehicle;
a position history calculator that calculates a position history of the front vehicle on a basis of a current position of the own vehicle, based on the positions of the front vehicle and the positions of the own vehicle which were detected at plural time points;
a region estimator that estimates a high probability region which is a region where the own vehicle probably travels and estimates a middle probability region which is a region where a possibility that the own vehicle travels is lower than the high probability region, based on the traveling state of the own vehicle; and
a preceding vehicle determiner that determines whether the front vehicle is a preceding vehicle which is traveling forward in a traveling lane where the own vehicle is traveling, based on the position history of the front vehicle, the high probability region, and the middle probability region.

2. The preceding vehicle determination system according to claim 1,
wherein the traveling state detector detects a curvature of a traveling course of the own vehicle, as the traveling state of the own vehicle, and
wherein the region estimator estimates the high probability region and the middle probability region, based on the curvature of the traveling course.

3. The preceding vehicle determination system according to claim 2,
wherein the region estimator estimates the high probability region and the middle probability region, based on the curvature of the traveling course, and an error width of curvature.

4. The preceding vehicle determination system according to claim 3,
wherein the region estimator estimates, as the high probability region, a region where an estimated lane which extends forward from the current position of the own vehicle according to the curvature of the traveling course and has a lane width is narrowed corresponding to the error width; and
estimates, as the middle probability region, a region other than the high probability region among a region where the estimated lane is expanded corresponding to the error width.

5. The preceding vehicle determination system according to claim 3,
wherein the region estimator estimates, as the high probability region, a region which becomes right side of a line which extends forward from an edge point of the traveling lane at left side of the current own vehicle, according to a curvature which is bent on right side from the curvature of the traveling course by the error width, and which becomes left side of a line which extends forward from an edge point of the traveling lane at right side of the current own vehicle, according to a curvature which is bent on left side from the curvature of the traveling course by the error width; and
estimates, as the middle probability region, a region other than the high probability region among a region which becomes right side of a line which extends forward from the edge point of the traveling lane at left side of the current own vehicle, according to a curvature which is bent on left side from the curvature of the traveling course by the error width, and which becomes left side of a line which extends forward from the right side lane end of the current own vehicle according to a curvature which is bent on right side from the curvature of the traveling course by the error width.

6. The preceding vehicle determination system according to claim 3,
wherein the region estimator limits the middle probability region so that the middle probability region does not expand more than a limit width in a lateral direction from an estimated lane which extends forward from the current position of the own vehicle according to the curvature of the traveling course and has a lane width.

7. The preceding vehicle determination system according to claim 6,
wherein the limit width is set less than or equal to a half value of lane width.

8. The preceding vehicle determination system according to claim 3,
wherein the region estimator changes the error width according to a speed of the own vehicle.

9. The preceding vehicle determination system according to claim 3,
wherein the region estimator calculates a filter value obtained by performing a low pass filter processing to the curvature of the traveling course;
calculates a deviation between the filter value, and the curvature of the traveling course which is delayed by a time delay due to the low pass filter processing, as a curvature error;
calculates a standard deviation of the curvature error, based on a time series data of the curvature error; and
calculates the error width, based on the standard deviation.

10. The preceding vehicle determination system according to claim 1,
wherein the traveling state detector detects lane boundary line shapes of the traveling lane of the own vehicle, as the traveling state of the own vehicle, and
wherein the region estimator estimates the high probability region and the middle probability region, based on the lane boundary line shapes of the traveling lane.

11. The preceding vehicle determination system according to claim 10,
wherein the region estimator detects the lane boundary line shapes of the traveling lane of the own vehicle, by performing a curve approximation;
sets the high probability region corresponding to a region which is interposed between the lane boundary line shape of left side and the lane boundary line shape of right side and in which an original data of white lines used for the curve approximation exists; and
set the middle probability region to a region which is interposed between the lane boundary line shape of left side and the lane boundary line shape of right side and which is other than the high probability region.

12. The preceding vehicle determination system according to claim 1,
wherein when a part of the position history of the front vehicle is outside the middle probability region and the high probability region, and a part of the position history of the front vehicle which is newer than the part of the position history of the front vehicle which is outside the middle probability region and the high probability region is not inside the high probability region, the preceding vehicle determiner determines that the front vehicle is not the preceding vehicle;
when a part of the position history of the front vehicle is outside the middle probability region and the high probability region, and a part of the position history of the front vehicle which is newer than the part of the position history of the front vehicle which is outside the middle probability region and the high probability region is inside the high probability region, the preceding vehicle determiner determines that the front vehicle is the preceding vehicle; and
when a part of position history of the front vehicle is not outside the middle probability region and the high probability region, and a part of the position history of the front vehicle is inside the high probability region, the preceding vehicle determiner determines that the front vehicle is the preceding vehicle.

13. The preceding vehicle determination system according to claim 1,
wherein the preceding vehicle determiner sets a determination position in order from a newer position about the position history of the front vehicle;
when the determination position is inside the high probability region, the preceding vehicle determiner determines that the front vehicle is the preceding vehicle and ends determination;
when the determination position is outside the middle probability region and the high probability region, the preceding vehicle determiner determines that the front vehicle is not the preceding vehicle and ends determination; and
when the determination position is outside the high probability region and is inside the middle probability region, the preceding vehicle determiner sets an older position by one as the determination position and repeatedly performs determination.

14. The preceding vehicle determination system according to claim 1, further comprising a driving control unit controller that performs automatic driving or driving support of the own vehicle, based on the position of the preceding vehicle.

15. The preceding vehicle determination system according to claim 1, further comprising a driving control unit controller that controls a vehicle distance between the preceding vehicle and the own vehicle,
wherein using a position history which becomes inside a determination standard distance which is set corresponding to the vehicle distance controlled by the driving controller, among the position history of the front vehicle, the preceding vehicle determiner determines whether the front vehicle is the preceding vehicle.

16. A preceding vehicle determination method comprising:
detecting a position and a traveling state of an own vehicle;
detecting a position of a front vehicle located in front of the own vehicle;
calculating a position history of the front vehicle on a basis of a current position of the own vehicle, based on the positions of the front vehicle and the positions of the own vehicle which were detected at plural time points;
estimating a high probability region which is a region where the own vehicle probably travels, based on the traveling state of the own vehicle, and estimates a middle probability region which is a region where a possibility that the own vehicle travels is lower than the high probability region; and
determining whether the front vehicle is a preceding vehicle which is traveling forward in a traveling lane where the own vehicle is traveling, based on the position history of the front vehicle, the high probability region, and the middle probability region.
